(19) United States
(12) Patent Application Publication
(10) Pub. No.: US 2012/0271609 A1
(43) Pub. Date: Oct. 25, 2012

(54) METHODS AND COMPUTING SYSTEMS FOR HYDROCARBON EXPLORATION

(75) Inventors: ANDREAS W. LAAKE, HANNOVER (DE); KRISTIJAN KORNPIHL, KOLN (DE); ANDREW BISHOP, AMPTHILL (GB)

(73) Assignee: WESTERNGECO L.L.C., HOUSTON, TX (US)

(21) Appl. No.: 13/451,338

(22) Filed: Apr. 19, 2012

Related U.S. Application Data
(60) Provisional application No. 61/477,328, filed on Apr. 20, 2011.

(51) Int. Cl. G06G 7/48

(52) U.S. Cl. 703/10; 703/9

(57) ABSTRACT

Methods and computing systems for hydrocarbon exploration are disclosed. In one embodiment, an integrated petroleum systems model is generated for an area of interest, wherein the integrated petroleum systems model is based on: a geological outline, a set of satellite remote sensing data, and a set of airborne remote sensing data.

### CROSS-REFERENCE TO RELATED APPLICATION

This application claims benefit of U.S. Provisional Patent Application Ser. No. 61/477,328 filed Apr. 20, 2011, which is incorporated herein by reference in its entirety.

### TECHNICAL FIELD

The disclosed embodiments relate generally to hydrocarbon exploration, and more particularly, to computing systems, workflows and methods for integrating multiple types of data for enhancing hydrocarbon exploration.

### BACKGROUND

The exploration for hydrocarbons in remote areas often suffers from the lack of sufficient information to make informed decisions about developing and then producing hydrocarbons from a given prospect. Moreover, many exploration workflows do not take advantage of the myriad amounts of data already available or that could be obtained about a given prospect. Finally, even when existing exploration workflows do use more than one type of data for enhancing an exploration workflow to judge the expected value of a given prospect, they fail to integrate many valuable and relevant data types into a useful form, such as an integrated petroleum system model for exploration.

Accordingly, there is a need for methods and computing systems that can employ faster, more efficient, and more accurate methods for integrating multiple types of data for improving hydrocarbon exploration. Such methods and computing systems may complement or replace conventional methods and computing systems for hydrocarbon exploration.

### SUMMARY

The above deficiencies and other problems associated with hydrocarbon exploration are reduced or eliminated by the disclosed methods and devices.

In accordance with some embodiments, a hydrocarbon exploration method is performed that includes: generating an integrated petroleum systems model for at least part of an area of interest, wherein the model generation includes: generating a geological outline that includes the area of interest; generating an enhanced geological map that includes the area of interest, wherein the enhanced geological map is based at least in part on the geological outline; and generating the integrated petroleum systems model based at least in part on the enhanced geological map.

In accordance with some embodiments, a computing system for hydrocarbon exploration is provided that includes at least one processor, at least one memory, and one or more programs stored in the at least one memory, wherein the one or more programs are configured to be executed by the one or more processors, the one or more programs including instructions for generating an integrated petroleum systems model for at least part of an area of interest, wherein the model generation includes: generating a geological outline that includes the area of interest; generating an enhanced geological map that includes the area of interest, wherein the enhanced geological map is based at least in part on the geological outline; and generating the integrated petroleum systems model based at least in part on the enhanced geological map.

In accordance with some embodiments, a computer readable storage medium is provided, the medium having a set of one or more programs for hydrocarbon exploration that include instructions that when executed by a computing system cause the computing system to: generate an integrated petroleum systems model for at least part of an area of interest. The instructions, when executed to generate the integrated petroleum systems model, will cause the computing system to generate a geological outline that includes the area of interest; generate an enhanced geological map that includes the area of interest, wherein the enhanced geological map is based at least in part on the geological outline; and generate the integrated petroleum systems model based at least in part on the enhanced geological map.

In accordance with some embodiments, a computing system for hydrocarbon exploration is provided that includes at least one processor, at least one memory, and one or more programs stored in the at least one memory; and means for generating an integrated petroleum systems model for at least part of an area of interest, wherein the model generation includes: means for generating a geological outline that includes the area of interest; means for generating an enhanced geological map that includes the area of interest, wherein the enhanced geological map is based at least in part on the geological outline; and means for generating the integrated petroleum systems model based at least in part on the enhanced geological map.

In accordance with some embodiments, an information processing apparatus for use in a computing system is provided, and includes means for generating an integrated petroleum systems model for at least part of an area of interest, wherein the model generation includes: means for generating a geological outline that includes the area of interest; means for generating an enhanced geological map that includes the area of interest, wherein the enhanced geological map is based at least in part on the geological outline; and means for generating the integrated petroleum systems model based at least in part on the enhanced geological map.

In accordance with some embodiments, a method is performed that includes generating an integrated petroleum systems model for at least part of an area of interest, wherein the integrated petroleum systems model is based at least in part on a geological outline, a set of satellite remote sensing data, and a set of airborne remote sensing data.

In accordance with some embodiments, a computing system is provided that includes at least one processor, at least one memory, and one or more programs stored in the at least one memory, wherein the one or more programs are configured to be executed by the one or more processors, the one or more programs including instructions for generating an integrated petroleum systems model for at least part of an area of interest, wherein the integrated petroleum systems model is based at least in part on a geological outline, a set of satellite remote sensing data, and a set of airborne remote sensing data.

In accordance with some embodiments, a computer readable storage medium is provided, the medium having a set of one or more programs including instructions that when executed by a computing system cause the computing system to generate an integrated petroleum systems model for at least part of an area of interest, wherein the integrated petroleum systems model is based at least in part on a geological outline, a set of satellite remote sensing data, and a set of airborne remote sensing data

In accordance with some embodiments, a computing system is provided that includes at least one processor, at least one memory, and one or more programs stored in the at least one memory; and means for generating an integrated petroleum systems model for at least part of an area of interest, wherein the integrated petroleum systems model is based at least in part on a geological outline, a set of satellite remote sensing data, and a set of airborne remote sensing data.

In accordance with some embodiments, an information processing apparatus for use in a computing system is provided, and includes means for generating an integrated petroleum systems model for at least part of an area of interest, wherein the integrated petroleum systems model is based at least in part on a geological outline, a set of satellite remote sensing data, and a set of airborne remote sensing data.

In accordance with some embodiments, a method is performed that includes: displaying a graphical user interface; and displaying a three-dimensional compilation within the graphical user interface, wherein the three-dimensional compilation is based at least in part on an integrated petroleum systems model.

In accordance with some embodiments, a computing system for hydrocarbon exploration is provided that includes at least one processor, at least one memory, and one or more programs stored in the at least one memory, wherein the one or more programs are configured to be executed by the one or more processors, the one or more programs including instructions for: displaying a graphical user interface; and displaying a three-dimensional compilation within the graphical user interface, wherein the three-dimensional compilation is based at least in part on an integrated petroleum systems model.

In accordance with some embodiments, a computer readable storage medium is provided, the medium having a set of one or more programs including instructions that when executed by a computing system cause the computing system to: display a graphical user interface; and display a three-dimensional compilation within the graphical user interface, wherein the three-dimensional compilation is based at least in part on an integrated petroleum systems model.

In accordance with some embodiments, a computing system is provided that includes at least one processor, at least one memory, and one or more programs stored in the at least one memory; and means for displaying a graphical user interface; and means for displaying a three-dimensional compilation within the graphical user interface, wherein the three-dimensional compilation is based at least in part on an integrated petroleum systems model.

In accordance with some embodiments, an information processing apparatus for use in a computing system is provided, and includes means for displaying a graphical user interface; and means for displaying a three-dimensional compilation within the graphical user interface, wherein the three-dimensional compilation is based at least in part on an integrated petroleum systems model.

In some embodiments, an aspect of the invention includes that the generation of the geological outline is based at least in part on a stratigraphic column having geological information about the area of interest.

In some embodiments, an aspect of the invention includes that the generation of the enhanced geological map is based at least in part on a combined remote sensing map.

In some embodiments, an aspect of the invention includes that the combined remote sensing map is based at least in part on one or more forms of data selected from a surface elevation and topographical structural model and satellite gravity data.

In some embodiments, an aspect of the invention includes that the surface elevation and topographical structural model is based at least in part on one or more forms of data selected from the group consisting of a digital elevation model, an optical satellite image, and a radar satellite image.

In some embodiments, an aspect of the invention includes that the generation of the integrated petroleum systems model is based at least in part on a thermal model.

In some embodiments, an aspect of the invention includes that the generation of the thermal model is based at least in part on one or more data types selected from the group consisting of stratigraphy data, well data, and heat flow data.

In some embodiments, an aspect of the invention includes that the generation of the integrated petroleum systems model is based at least in part on a risk assessment based at least in part on the thermal model.

In some embodiments, an aspect of the invention involves basing the generation of the integrated petroleum systems model on airborne collected remote sensing data selected from the group consisting of airborne LiDAR data, airborne gravity data, and airborne magnetic data.

In some embodiments, an aspect of the invention includes that the generation of the integrated petroleum systems model is based at least in part on an enhanced surface structure that is based at least in part on the airborne LiDAR data.

In some embodiments, an aspect of the invention includes that the generation of the integrated petroleum systems model is based at least in part on a high-resolution basin structure that is based at least in part on the airborne gravity data.

In some embodiments, an aspect of the invention includes that the generation of the integrated petroleum systems model is based at least in part on a high-resolution basin structure that is based at least in part on the airborne magnetic data.

In some embodiments, an aspect of the invention involves designing a seismic survey based at least in part on the integrated petroleum systems model.

In some embodiments, an aspect of the invention involves preparing a three-dimensional compilation based at least in part on the integrated petroleum systems model and a digital elevation model.

In some embodiments, an aspect of the invention involves identifying a potential reservoir within the three-dimensional compilation.

Thus, the computing systems and methods disclosed herein are faster, more efficient methods for hydrocarbon exploration. These computing systems and methods increase hydrocarbon exploration effectiveness, efficiency, and accuracy. Such methods and computing systems may complement or replace conventional methods for hydrocarbon exploration.

### BRIEF DESCRIPTION OF THE DRAWINGS

For a better understanding of the aforementioned embodiments as well as additional embodiments thereof, reference should be made to the Description of Embodiments below, in conjunction with the following drawings in which like reference numerals refer to corresponding parts throughout the figures.

FIG. 1 illustrates a computing system in accordance with some embodiments.

FIGS. 2-4 illustrate methods of hydrocarbon exploration in accordance with some embodiments.

FIGS. 5-21 illustrate various data types and examples of data sources that may be used for generating petroleum systems models in accordance with some embodiments.

FIGS. 22-23 and 24-1 through 24-3 illustrate various geological data types and geological data analysis tools that may be used for generating a petroleum systems model in accordance with some embodiments.

FIG. 25 illustrates an example of a petroleum systems model in accordance with some embodiments.

FIGS. 26-1 and 26-2 are flow diagrams illustrating methods of hydrocarbon exploration in accordance with some embodiments.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both, objects or steps, respectively, but they are not to be considered the same object or step.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

### Computing Systems

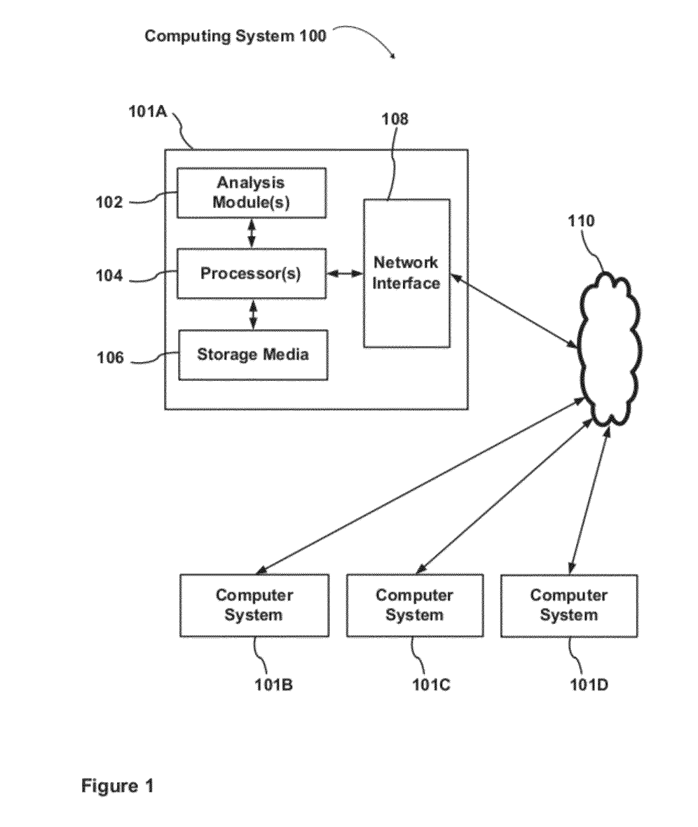

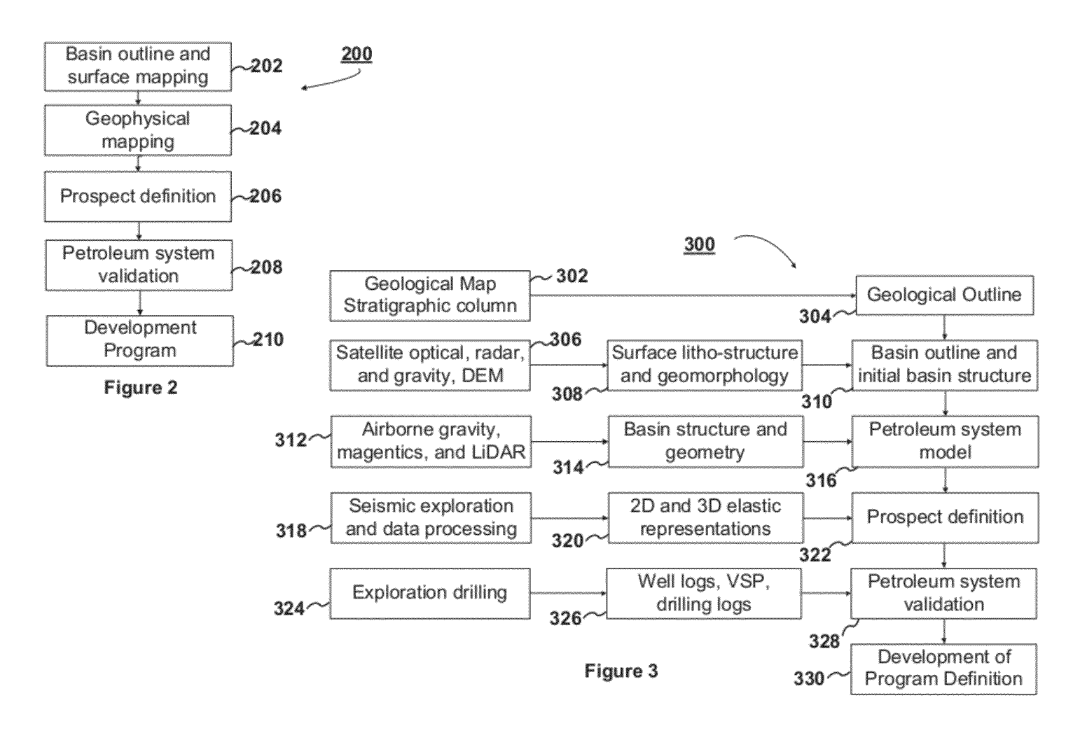

FIG. 1 depicts an example computing system 100 in accordance with some embodiments. The computing system 100 can be an individual computer system 101A or an arrangement of distributed computer systems. The computer system 101A includes one or more analysis modules 102 that are configured to perform various tasks according to some embodiments, such as the tasks depicted in FIGS. 2-4. To perform these various tasks, analysis module 102 executes independently, or in coordination with, one or more processors 104, which is (or are) connected to one or more storage media 106. The processor(s) 104 is (or are) also connected to a network interface 108 to allow the computer system 101A to communicate over a data network 110 with one or more additional computer systems and/or computing systems, such as 101B, 101C, and/or 101D (note that computer systems 101B, 101C and/or 101D may or may not share the same architecture as computer system 101A, and may be located in different physical locations, e.g., computer systems 101A and 101B may be on a ship underway on the ocean, while in communication with one or more computer systems such as 101C and/or 101D that are located in one or more data centers on shore, other ships, and/or located in varying countries on different continents).

A processor can include a microprocessor, microcontroller, processor module or subsystem, programmable integrated circuit, programmable gate array, or another control or computing device.

The storage media 106 can be implemented as one or more computer-readable or machine-readable storage media. Note that while in the example embodiment of FIG. 1 storage media 106 is depicted as within computer system 101A, in some embodiments, storage media 106 may be distributed within and/or across multiple internal and/or external enclosures of computing system 101A and/or additional computing systems. Storage media 106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs), digital video disks (DVDs), BluRays or other high-capacity media; or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 100 is only one example of a computing system, and that computing system 100 may have more or fewer components than shown, may combine additional components not depicted in the example embodiment of FIG. 1, and/or computing system 100 may have a different configuration or arrangement of the components depicted in FIG. 1. The various components shown in FIG. 1 may be implemented in hardware, software, or a combination of both, hardware and software, including one or more signal processing and/or application specific integrated circuits.

Further, the steps in the processing methods described above may be implemented by running one or more functional modules in information processing apparatus such as general purpose processors or application specific chips, such as ASICs, FPGAs, PLDs or other appropriate devices. These modules, combinations of these modules, and/or their combination with general hardware are all included within the scope of protection of the invention.

Additionally, those with skill in the art will recognize that computing systems, such as the example of computing system 100, may be configured to display graphical user interfaces that display one or more types of data, including without limitation, geological data, geological data analysis tools, petroleum systems models, three-dimensional compilations of geological data, models, etc.

Attention is now directed to FIG. 2, which is a high-level method 200 for a hydrocarbon development program in accordance with some embodiments. Method 200 is a high-level overview of the hydrocarbon exploration and development process, and begins by generating a basin outline and surface information mapping (202). Geophysical mapping (204) is performed, taking into account the basin outline and surface information. In some embodiments, one or more petroleum system models may be generated. One or more prospect definitions are then generated (206) based on the geophysical mapping, basin outline, surface mapping, and geophysical data interpretation, and in some embodiments, the one or more petroleum system models. Following review of the prospect definitions, a prospect with an expected or predicted petroleum system is selected for validation, which may include surveying, drilling, and other validation techniques (208). Based on the validation results, a development program is generated for the petroleum system (210).

Attention is now directed to FIG. 3, which is a more detailed method 300 for a hydrocarbon development program in accordance with some embodiments.

Method 300 begins by integrating one or more legacy geological data sources (302), such as geological map(s) and/or stratigraphic column(s), to form (304) a geological outline of an area for potential hydrocarbon development.

Method 300 proceeds to incorporate satellite remote sensing data by collecting (306) satellite data of the area, including, but not limited to, one or more of optical data, radar data, gravity data, and one or more digital elevation models (referred to herein as “DEM” or “DEMs”) of the area. Surface litho-structure and geomorphology of the area are then included (308) to generate a basin outline with an initial basin structure of the area (310).

Method 300 then proceeds to incorporate airborne remote sensing data by collecting (312) airborne acquired data of the area, including, but not limited to, one or more of airborne collected gravity data, magnetic, electromagnetic, magnetotelluric, and LiDAR data. Additionally, in some embodiments, basin structural and geometrical data are incorporated (314) along with the airborne remote sensing data to form an integrated petroleum system model (316). In some embodiments, the geological outline and the basin outline and initial basin structure are integrated with the airborne collected data to form the integrated petroleum system model (e.g., each of the data types as discussed up to this point for method 300 may be incorporated into the petroleum system model, i.e., the geological outline 304, basin outline and initial basin structure 310, airborne data 312, and basin structure and geometry 314 are incorporated into petroleum system model 316).

Based on the petroleum system model, legacy information, geographical information, and any data prepared in the course of method 300 about the area, method 300 proceeds to seismic exploration and initial data processing of the acquired data (318). In varying embodiments, many seismic data processing techniques may be employed, including without limitation, interferometry, interpolation, demultiple analysis and subtraction, stacking, migration, including reverse time migration, acoustic and/or elastic full waveform inversion, depth migration, etc., to form one or more 2D and/or 3D representations of the area or a subset of the area (320). In some embodiments, 2D and/or 3D representations of the area or subset of the area may be an acoustic representation. In some embodiments, 2D and/or 3D representations of the area or subset of the area may be an elastic representation. Based at least in part on the one or more 2D and/or 3D representations of the area (or subset of the area), a prospect definition may be prepared (322). The prospect definition may identify one or more potential petroleum systems (comprising e.g., hydrocarbon reservoirs, hydrocarbon fields that may span more than one formation and thus span one or more petroleum systems, etc.) for potential development. This development may be premised on validating an identified petroleum system.

In order to validate an identified petroleum system, exploration drilling (324) may be performed, and in the course of drilling, well logs, vertical seismic profiling (VSP), and drilling logs may be collected (326) for analysis and assistance in interpreting and validating (328) the petroleum system that was identified in the prospect definition.

As such, the development (330) of a hydrocarbon development program may be based at least in part on the petroleum system validation, which was based at least in part on the prospect definition, which was based at least in part on the integrated petroleum system model.

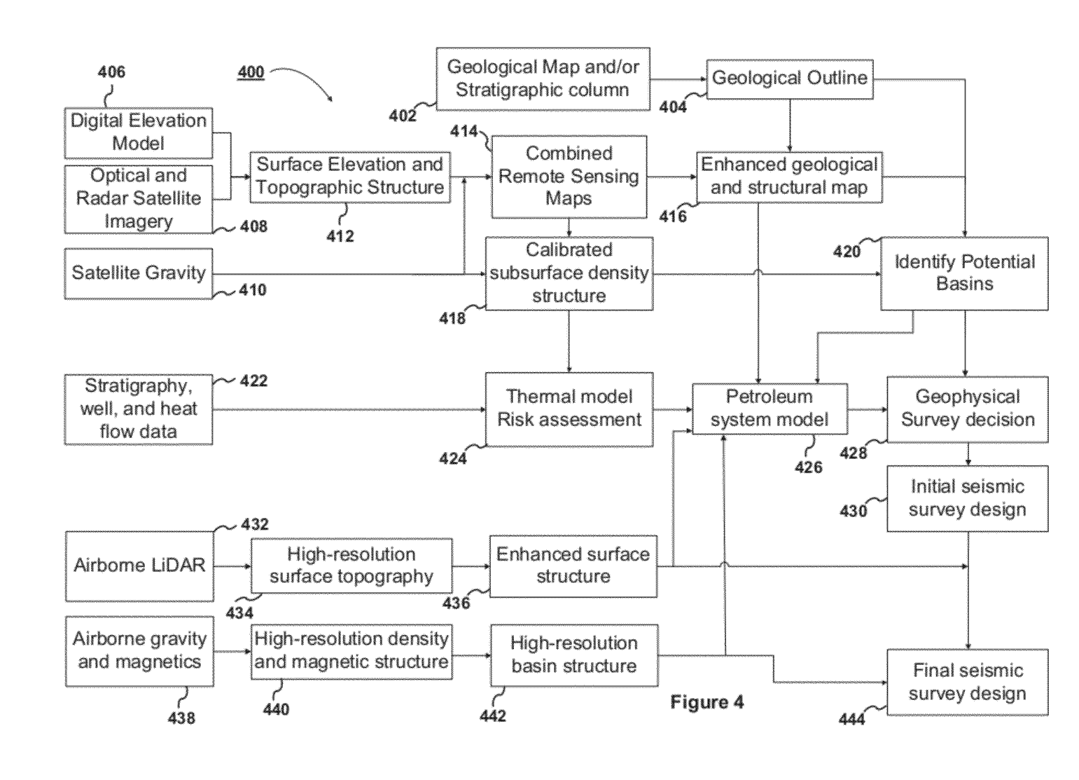

Attention is now directed to FIG. 4, which is integrated petroleum system modeling workflow 400 in accordance with some embodiments. During the discussion of FIG. 4, reference may be made to additional figures that illustrate examples of data, tools, and/or other information that may be utilized as part of workflow 400.

The first step aims at collecting the legacy geological information from the area of interest itself as well as from adjacent areas. In varying embodiments, this information may include one or more of:
a stratigraphic column;
a geological map;
surface and subsurface lithology; and
surface and subsurface structure.

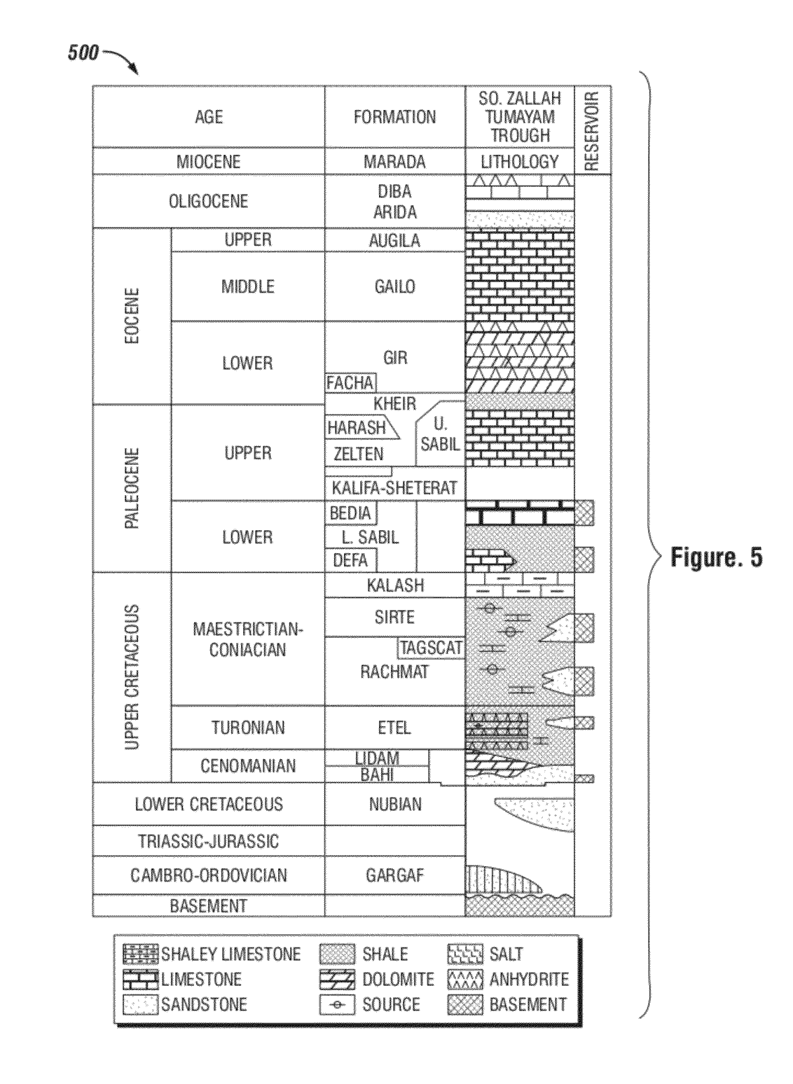

A stratigraphic column provides information about the subsurface strata, their age and deposition history (see, e.g., FIG. 4 workflow 400, stratigraphic column 402, an example of which is illustrated in FIG. 5, column 500, which is a stratigraphic column in accordance with some embodiments, which shows intervals with potential for a petroleum system). In essence, a stratigraphic column can provide a generalized one-dimensional model of the subsurface, including without limitation, strata types, including their potential for hydrocarbons, definitions of the intervals to be studied in the petroleum system modeling, etc. Additionally, estimates for the extent of, structure of and subsidence history of various sub-surface features can be incorporated into a stratigraphic column.

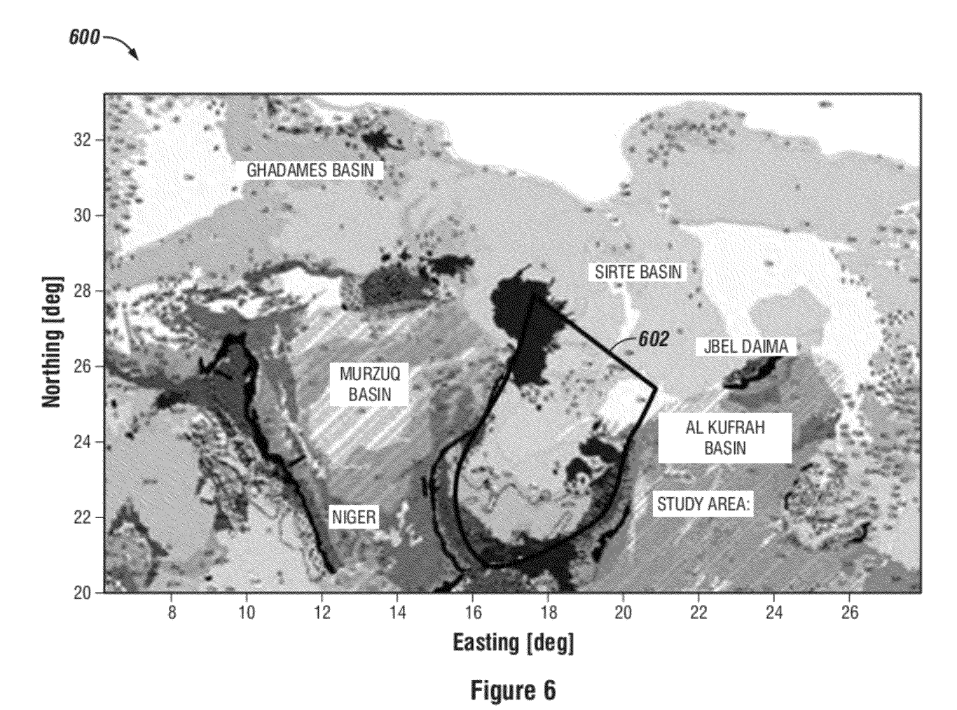

In some embodiments, when detailed data for the area of interest is missing or could be supplemented with additional pertinent information, areas adjacent to the area of interest may be analyzed for their surface and subsurface lithology and structure. In some embodiments, information is compiled such as estimates of the subsurface structure and surface geological maps (see, e.g., FIG. 4 workflow 400, geological map 402, an example of which is illustrated in FIG. 6, surface geological map 600); surface geological maps can provide data regarding outcrops which relate to strata and ages of formations that could be found in the subsurface.

In some embodiments, these data facilitate identification of an outline of the area of interest for the petroleum system study (see, e.g., FIG. 4 workflow 400, geological outline 404, an example of which is illustrated in FIG. 6, outline 602).

Varying embodiments of the workflow in method 400 include utilization of different remote sensing data to obtain information about the subsurface via lithological and structural interpretation.

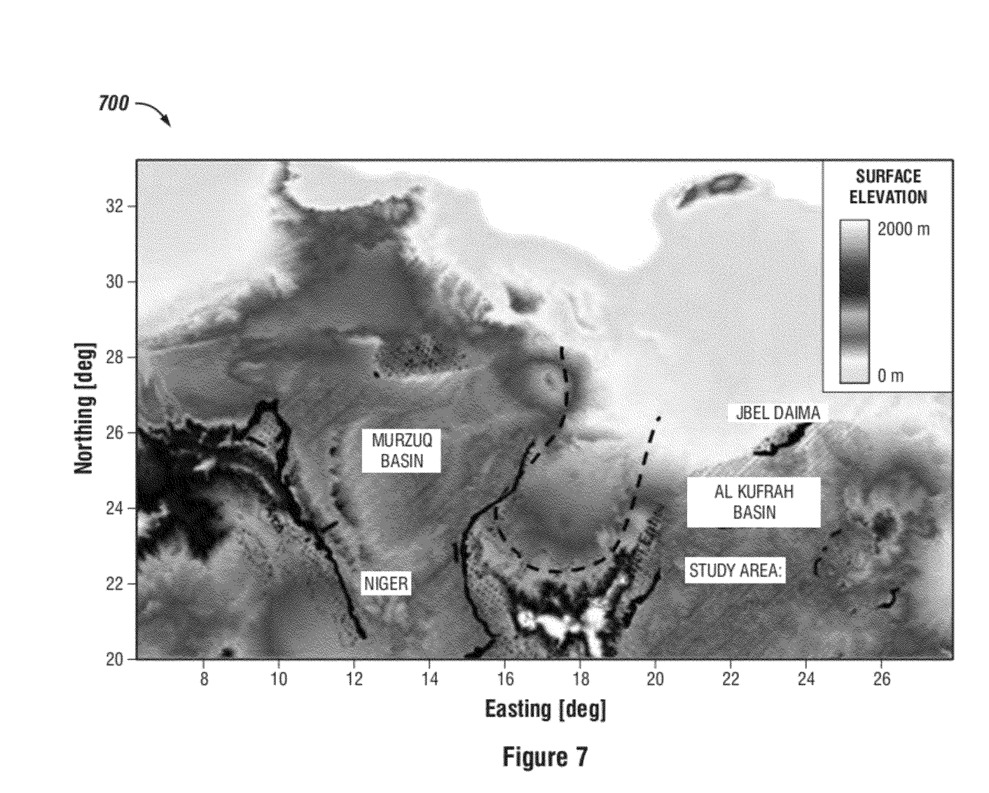

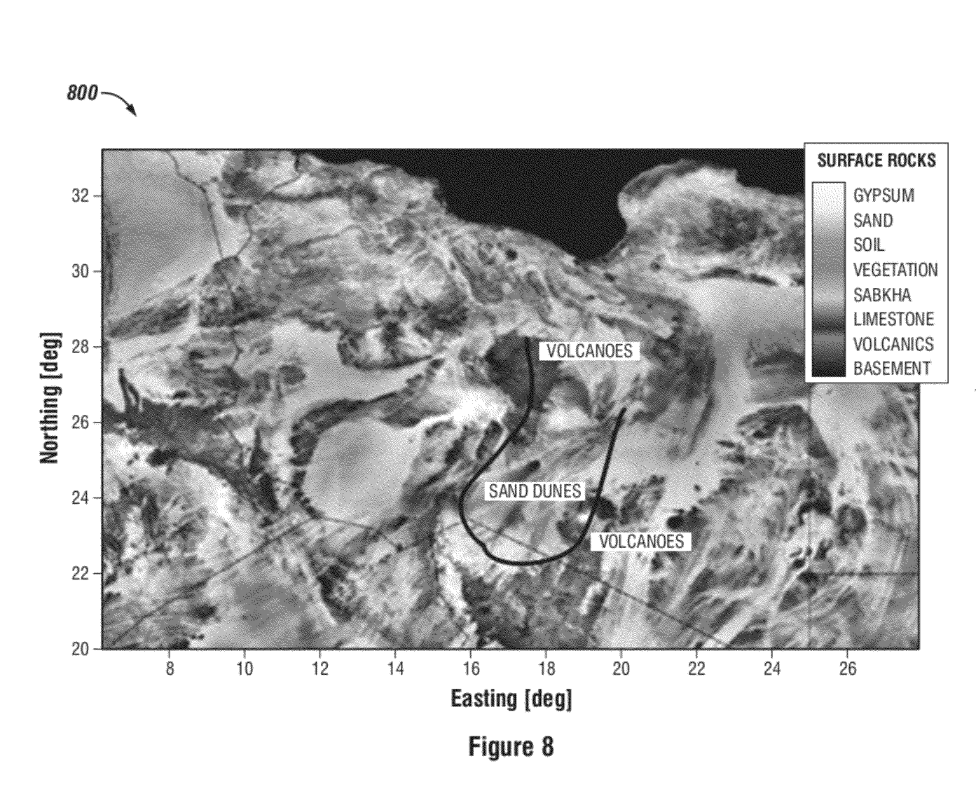

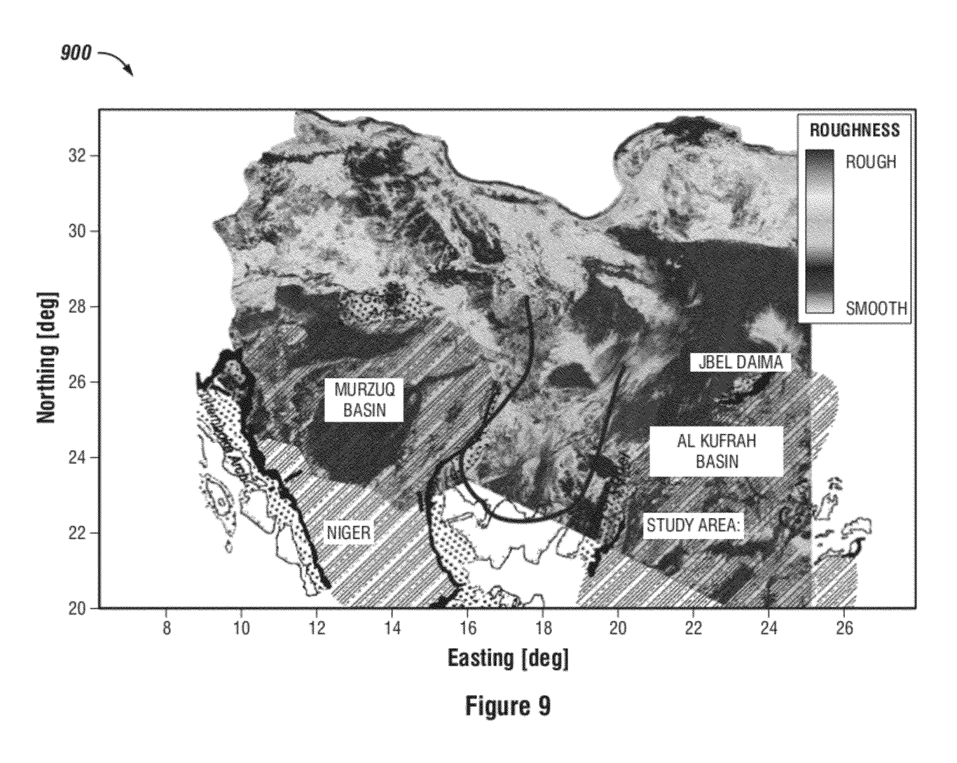

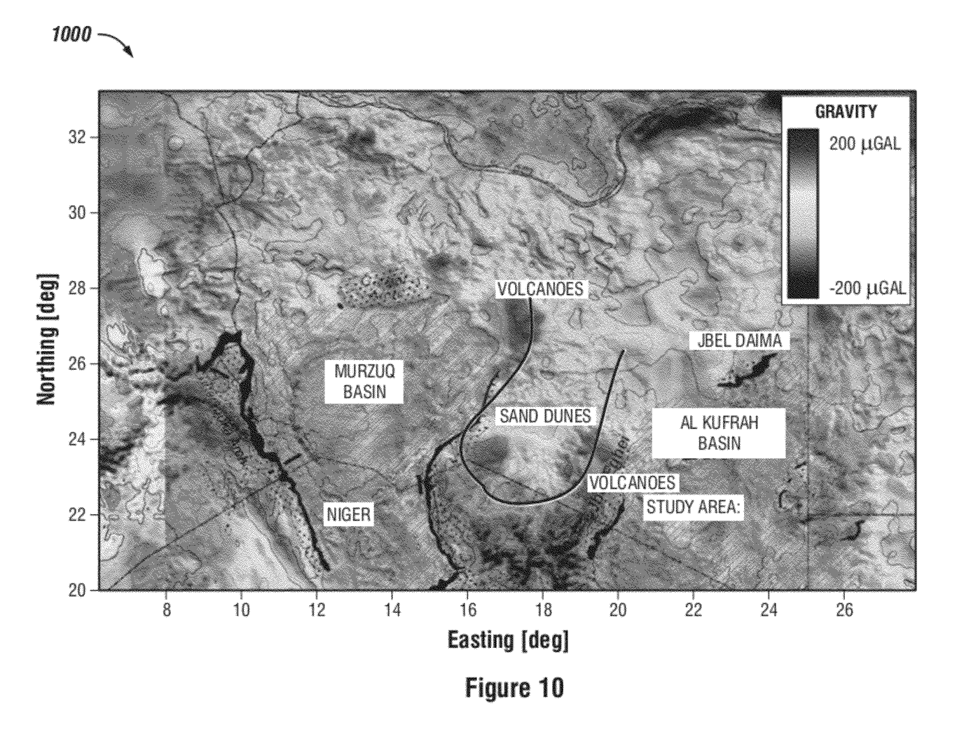

As those with skill in the art will appreciate, in some cases, an underlying assumption may be made that subsurface structural movements often result in structural lineaments at the surface. Where this assumption is valid, surface topography and lithology may enhance identification of these lineaments. Therefore, one or more surface digital elevation models (DEMs) of the area of interest (see, e.g., FIG. 4 workflow 400, digital elevation model 406, an example of which is illustrated in FIG. 7) and multi-spectral optical satellite imagery of the area of interest (see, e.g., FIG. 4 workflow 400, optical and radar satellite imagery 408, an example of which is illustrated in FIG. 8, satellite image map with lithology information 800) may provide information about surface lineaments within the area of interest. The back scatter of satellite radar data gives further clues on surface lineaments the area of interest, either directly through mapping hard rock outcrops from strong surface back scatter or via delineation of paleo-drainage patterns through significant absorption of radar waves in the near-surface (see, e.g., FIG. 4 workflow 400, optical and radar satellite imagery 408, an example of which is illustrated in FIG. 9, satellite image map based on radar 900). Additionally, an estimate for the thickness of the sedimentary cover in the area of interest, e.g., the depth of crystalline or metamorphic basement, may be obtained from satellite gravity mapping (see, e.g., FIG. 4 workflow 400, satellite gravity imagery 410, an example of which is illustrated in FIG. 10, satellite image map based on gravity 1000).

Additionally, in some embodiments, one or more DEMs of the area of interest may be combined with satellite optical and/or radar-based imagery of the area of interest to generate a set of surface elevation and topographical structural data of the area of interest (see, e.g., FIG. 4, DEM 406 and Optical and Radar Satellite Imagery 408 combined to generate surface elevation and topographical structure 412).

In some circumstances, a potential basin structure may be outlined by an elevated rim of hard rock in the digital elevation model and the radar back scatter map, which may also appear as a distinct lithological unit in the satellite image. An indication of a subsurface basin may be indicated by an area of low gravity. As those with skill in the art will appreciate, in some geophysical regions, the analysis of multiple data sets can enhance and/or provide stronger evidence to establish a basin than reliance on one data type alone.

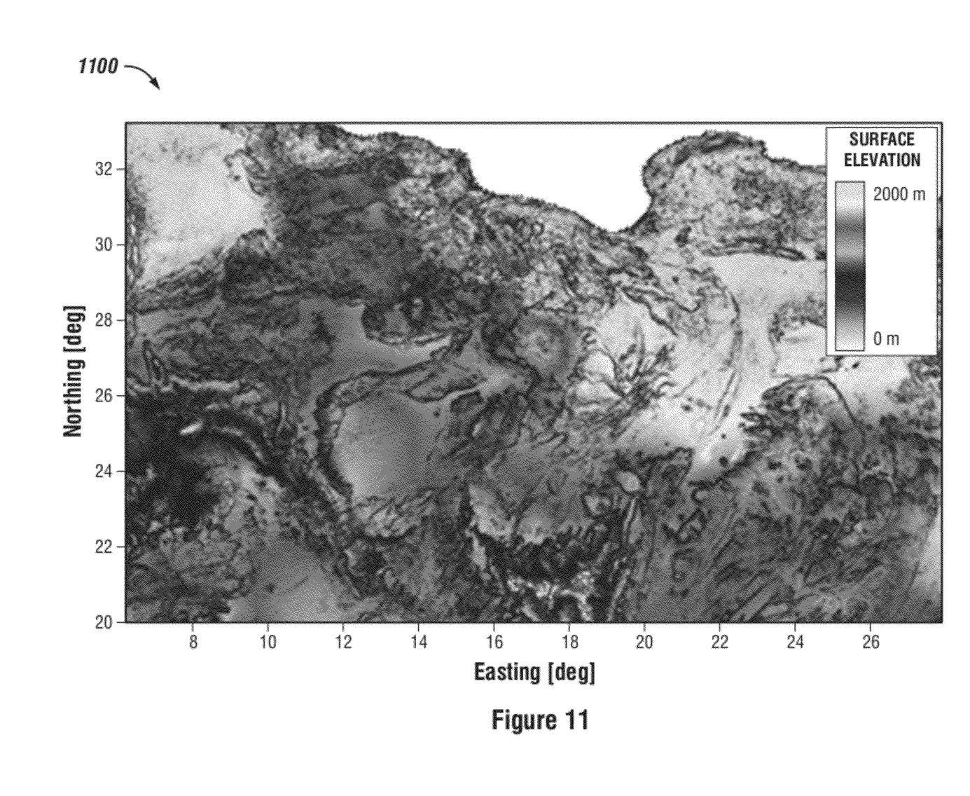

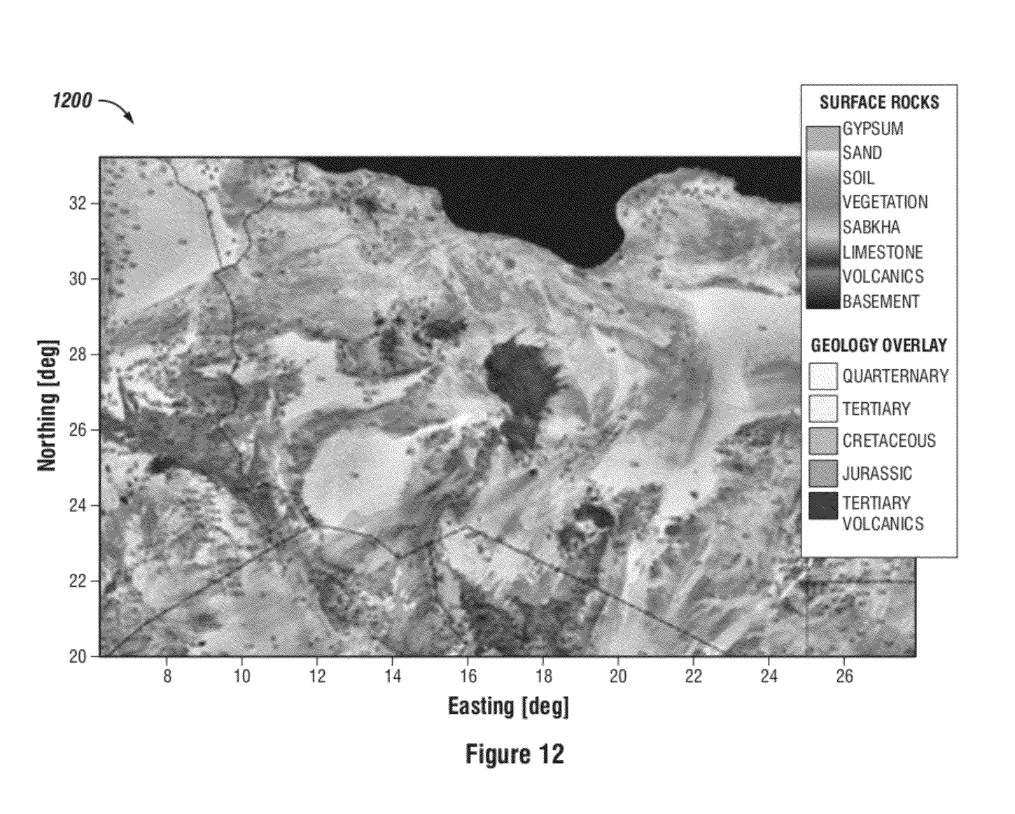

Accordingly, one or more combined remote sensing maps allowing the simultaneous analysis of more than one parameter at a time can be developed (see, e.g., FIG. 4, DEM 406 and Optical and Radar Satellite Imagery 408 combined to generate surface elevation and topographical structure 412, which in turn are used to generate one or more combined remote sensing maps 414, which may also be based on satellite gravity data 410). In some embodiments, a geomorphology map is prepared by combining topography and the gradients of the surface elevation; further embodiments also include short wave infrared bands of multi-spectral satellite imagery since it highlights structural and lithological boundaries in connection with the elevation (see, e.g., FIG. 11). In some embodiments, a combined remote sensing map illustrating the correlation of surface rock type with the geological age is shown in a photo-geological map (see, e.g., FIG. 12), which provides information about rocks of high density which might influence the satellite gravity measurement.

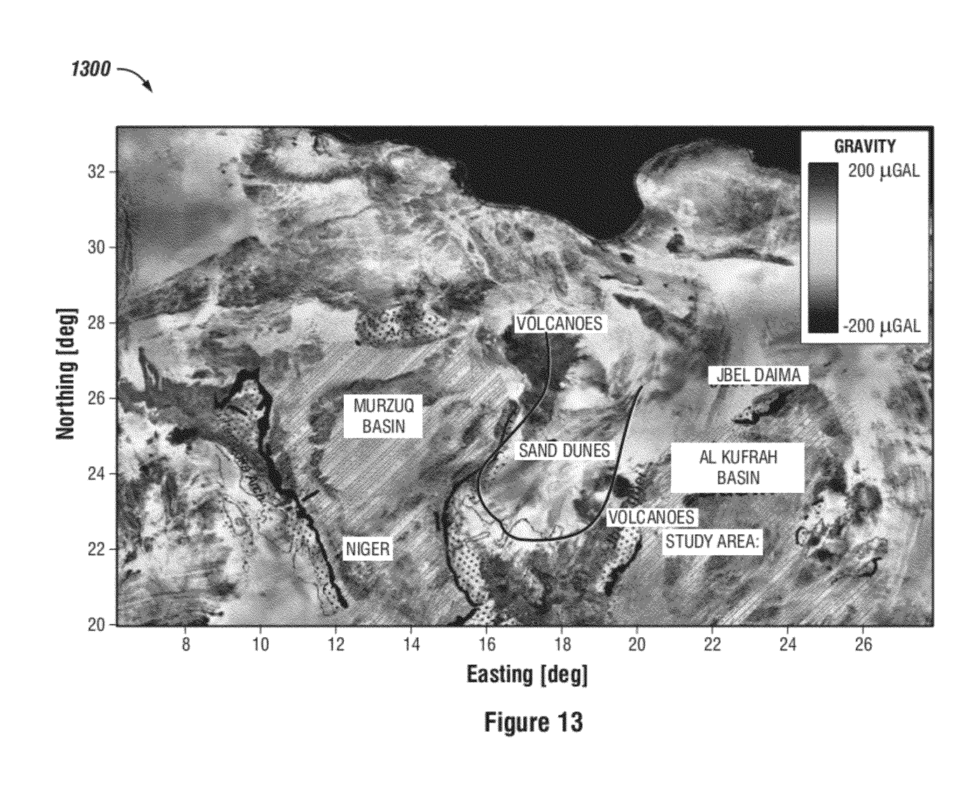

In some embodiments, a gravity surface lithology map is prepared from the combination of gravity and surface lithology from the short wave infrared bands of multi-spectral imagery allows the correlation of surface lineaments with the structure of the basement measured by the gravity (see, e.g., FIG. 13). If available, the overlay of the estimated depth to basement on the gravity map may provide an insight in the perceived structure of the basement.

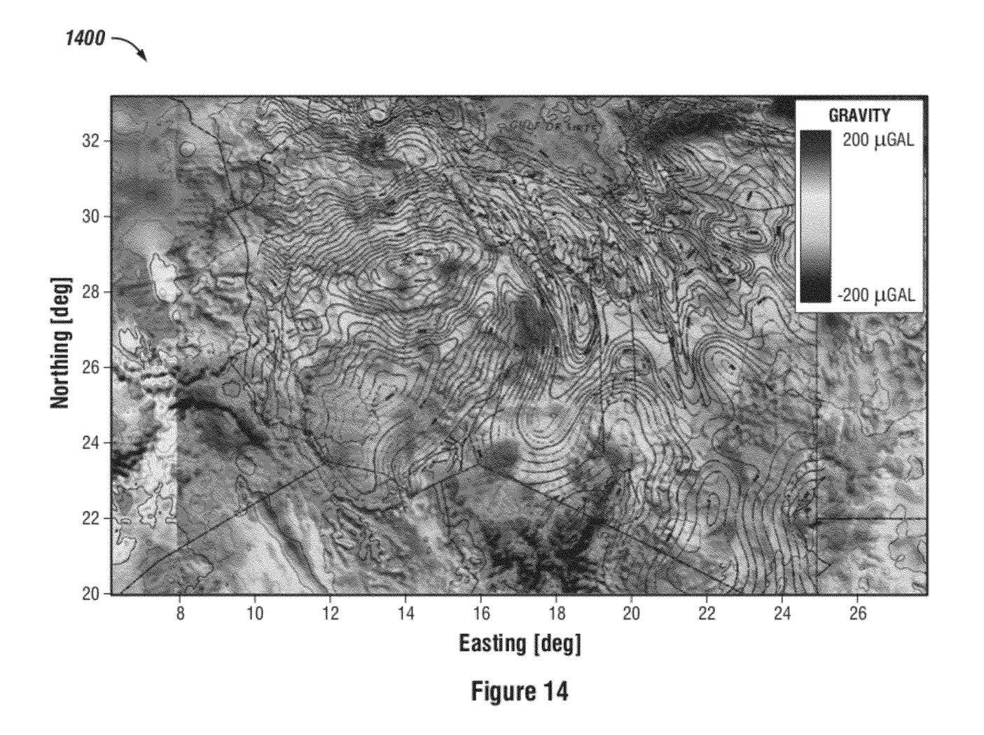

Additionally, in some embodiments, a combined remote sensing map in the form of a gravity structure map may be developed based on any appropriate information, including, but not limited to, DEM, Optical Satellite Imagery, Radar Satellite Imagery, surface elevation data, topographical structure data, and/or satellite gravity data (see e.g., gravity structure map 1400, FIG. 14; FIG. 4, combined remote sensing map 414).

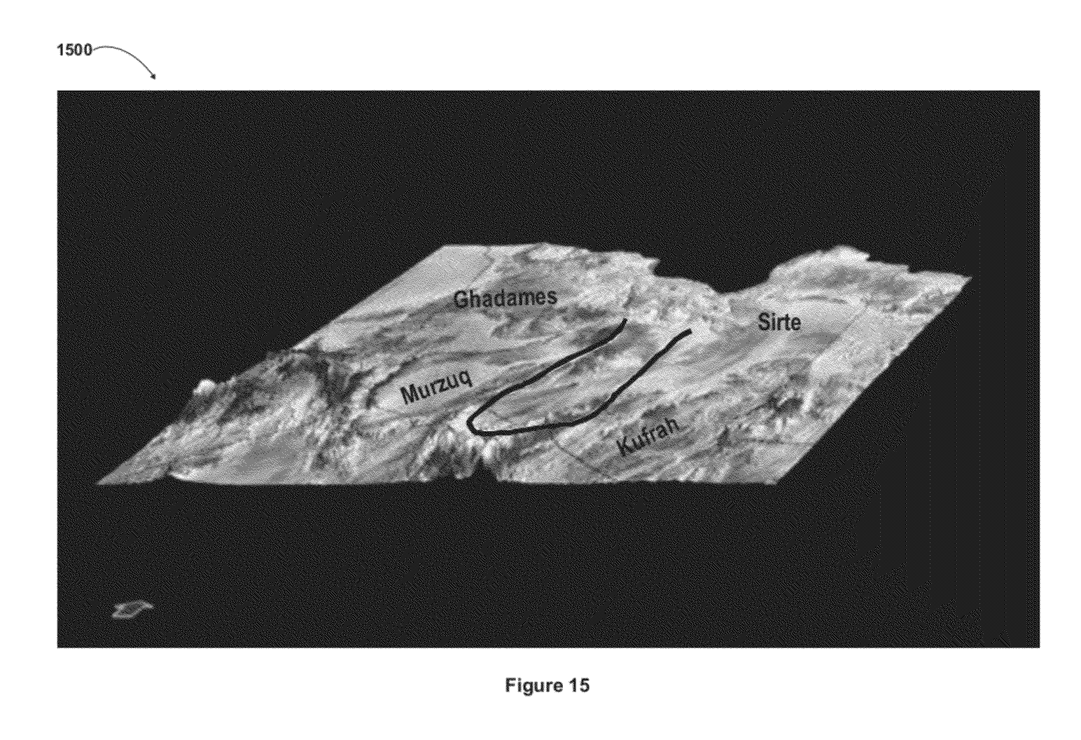

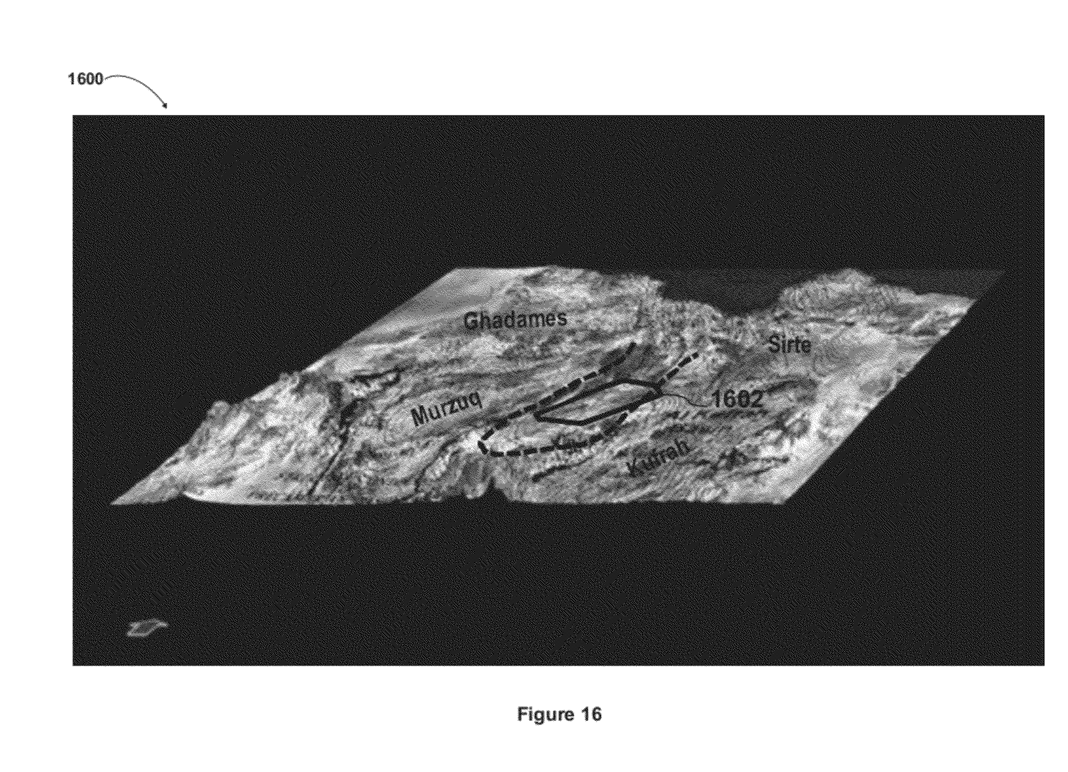

After analyzing data in map view, one or more selected maps can be draped over an appropriate model, (e.g., a digital elevation model) to generate one or more enhanced geological and structural maps for a 3D analysis (e.g., FIG. 4, enhanced geological and structural map 416). In some embodiments, a geomorphological map (FIG. 15, map 1500) may be prepared, which highlights the correlation of the surface topography with the litho-structure. In some embodiments, a gravity—lithology map (FIG. 16, map 1600 that includes example target area 1602) may be prepared, which reveals the correlation between surface litho-structure and the structure of the basement in the gravity data.

Additionally, in some embodiments, one or more combined remote sensing maps may be used in conjunction with satellite gravity data to generate a calibrated subsurface density structure (e.g., FIG. 4, calibrated subsurface density structure 418). As a non-limiting example, in the case that fault(s) extend from the basement up to the surface, the fault outcrop at the surface may be mapped from satellite optical and/or radar data and correlated with the satellite gravity data to establish the fault.

Continuing in integrated petroleum system modeling workflow 400, one may review geological outlines 404, enhanced geological and structural maps 416, and/or calibrated subsurface density structures 418 in order to identify one or more potential basins for further analysis (see, e.g., FIG. 4, identification of potential basins 420).

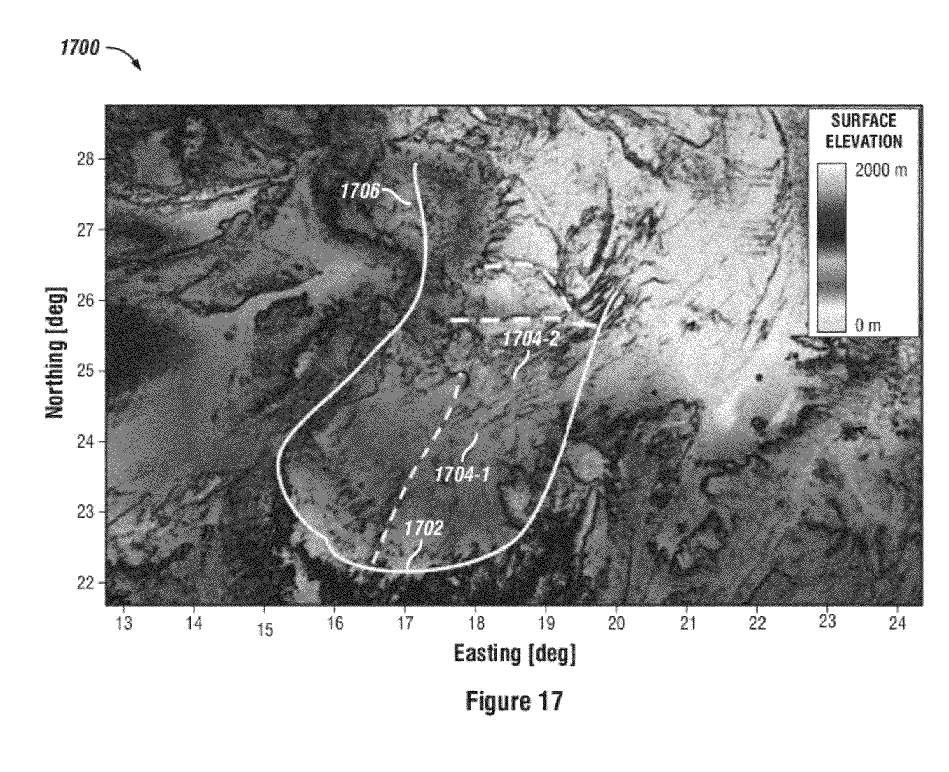

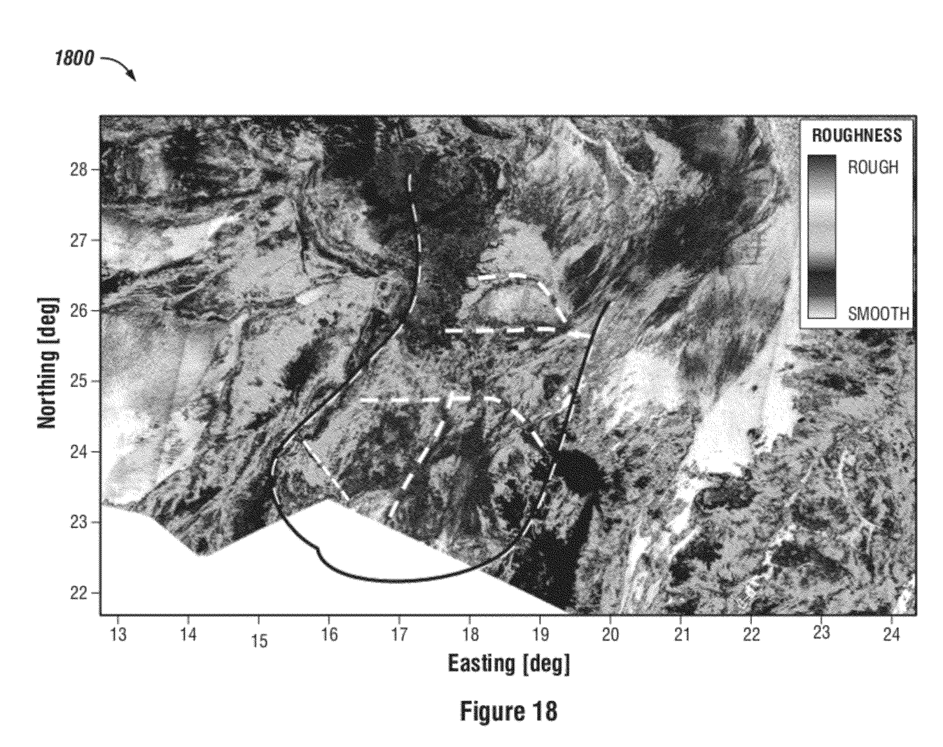

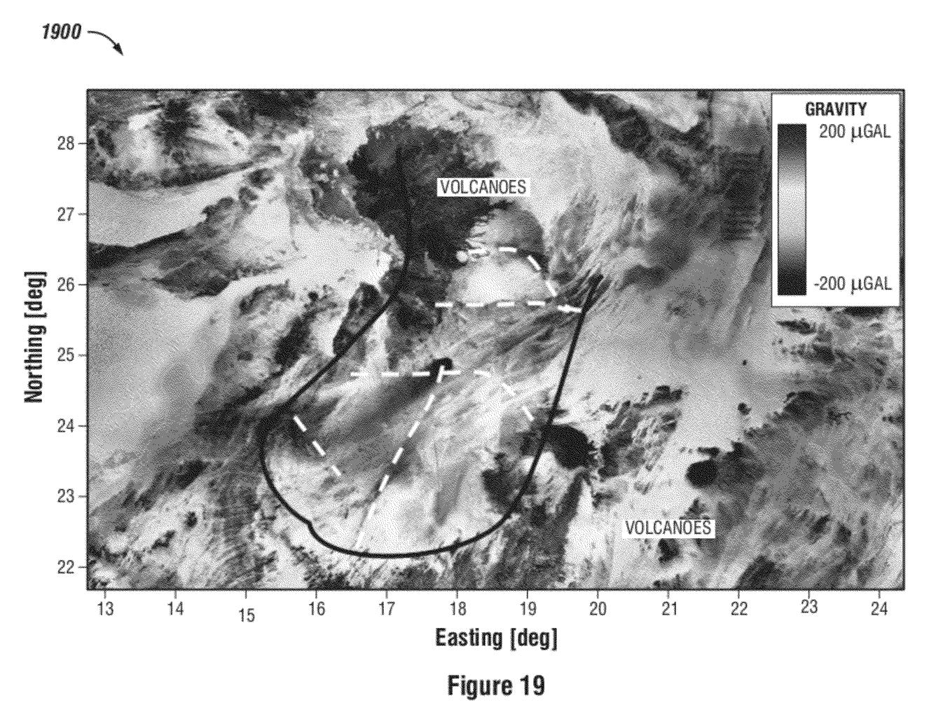

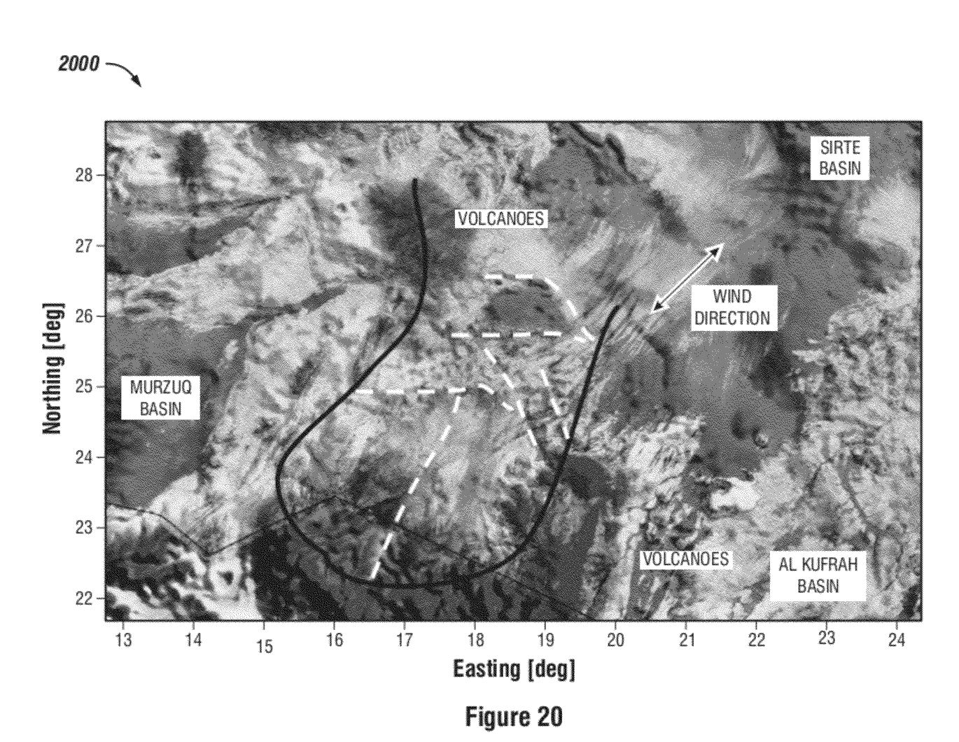

Once a potential basin is identified, the analysis is focused on the area of interest associated with the potential basin. For example, geomorphology of an area may be analyzed to find geological features that may influence basin placement. Accordingly, in some embodiments, analysis of remote sensing data may be performed towards this end, including without limitation, one or more of surface elevation analysis, radar roughness analysis, gravity—surface lithology analysis, and gravity—surface roughness analysis, which are illustrated by the examples of FIGS. 17-20, respectively. In the example of FIG. 17, the following geological features may be identified from the geomorphology analysis: identification of an outline of the basin 1702 as represented by a topographic ridge; sand dunes (e.g., the smoothly bended structures 1704-1 and 1704-2 in the center), a surface volcano 1706 at the northern western edge of the basin.

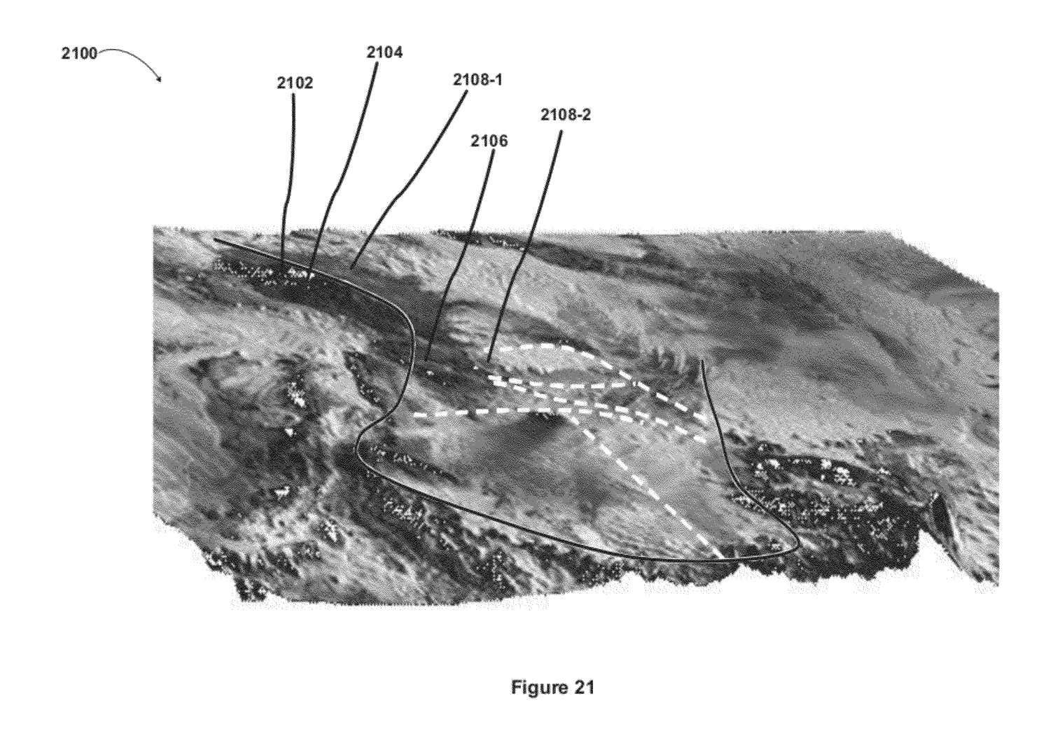

In some embodiments, rendering of a remote sensing data type into a map in 3D can highlight the structural image of the area of interest and how a basin may lie within (see, e.g., FIG. 21). In the example of FIG. 21, some surface structures are not correlated with the subsurface structure. For example, large volcanic complex 2102 shows a partly elevated basement 2104, where dense magma channel 2106 feeds the center of the volcanic complex 2102. The outer edges of the volcanic complex, however, appear as a thin surface sheet covering a deeper sedimentary basin (locations 2108-1 and 2108-2). The isolated volcano within the basin is not correlated with a gravity anomaly. This means that the magma chamber is too small to pull the basement up. This feature will therefore have only a minor impact on the petroleum history of the basin.

In some embodiments, stratigraphy and/or well data may be analyzed. As discussed above, one or more DEMs and a basement contour map generated in accordance with some embodiments, provide information relating to the basin structure and geometry in the area of interest. In some embodiments, analogs (i.e., information regarding comparable structures to the area of interest) from parts of the basin where greater information has already been collected may be used as guidelines to populate the basin stratigraphy in the area of interest. Additionally, in some embodiments, lithology information can be derived from general stratigraphic charts from the area of interest, and stratigraphic thicknesses can be estimated from reference cross sections corresponding to the area of interest. The data from such cross sections, which may include information about how subterranean layers correspond to past geological eras, allows reconstructing the structural evolution of the basin in past geological eras, and thereby, the subsidence history associated with subterranean layers in the area of interest. This subsidence history through time, i.e., the change of subsidence velocity and amount along the evaluated cross section, reveals the geodynamic story of the part of the earth's crust that corresponds to the area of interest. From this information, a heat flow model through geologic time can be modeled based at least in part on the stratigraphy data, and may in some embodiments also rely on well data (see FIG. 4, stratigraphy, well, and heat flow data 422).

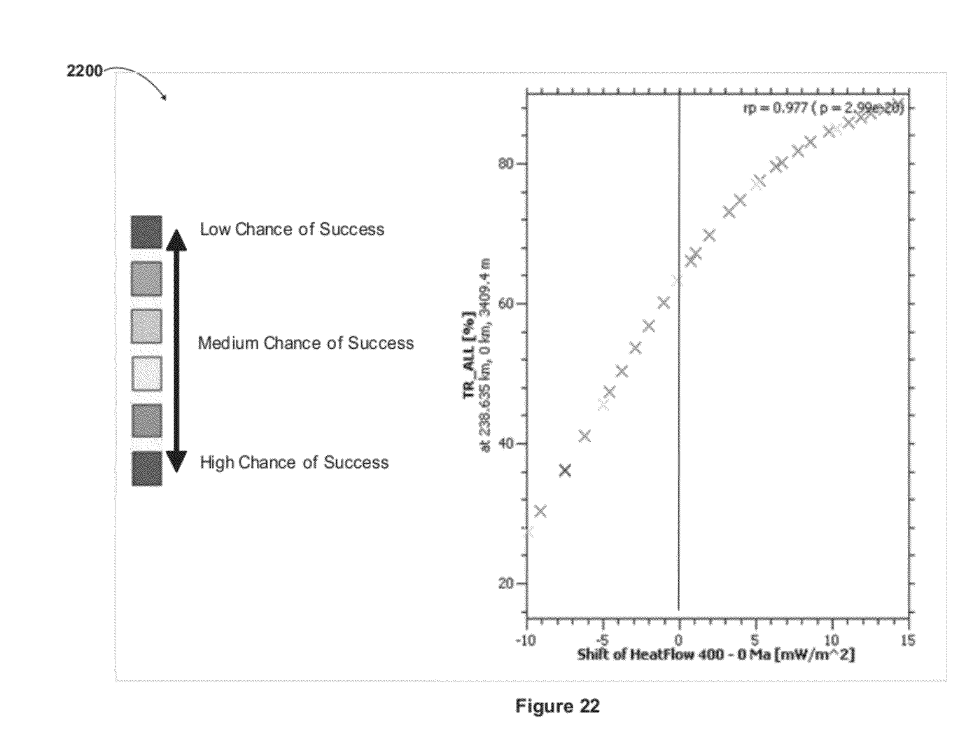

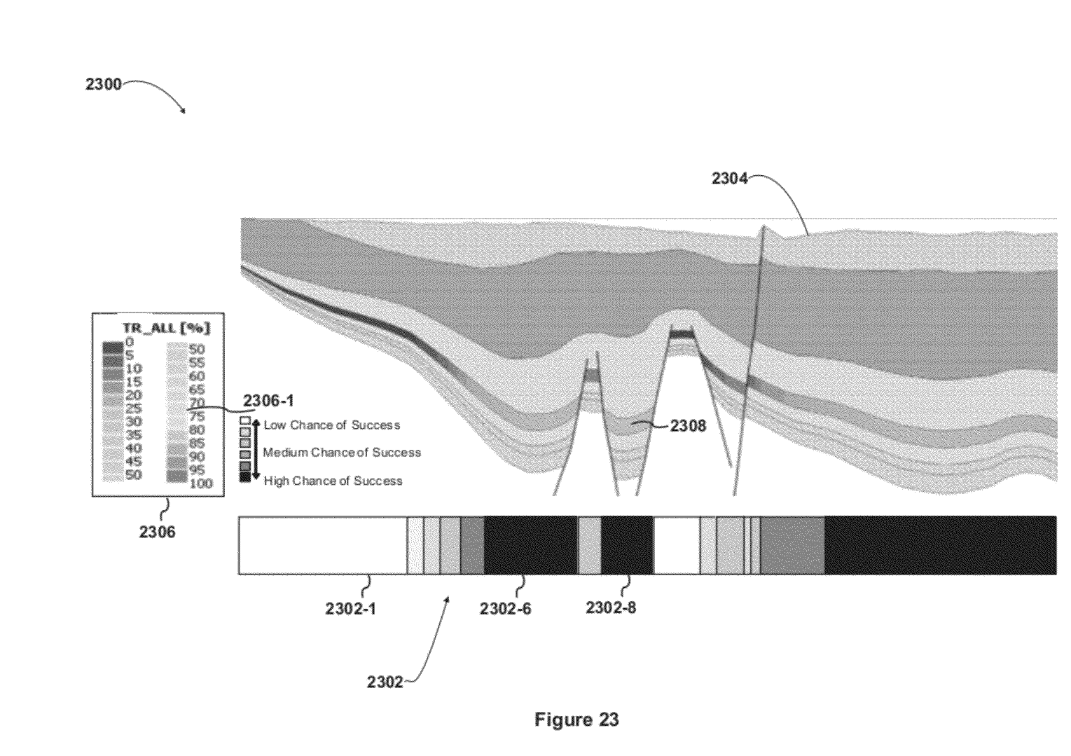

In some embodiments, a heat flow model based on stratigraphy and/or well data may be used as a boundary condition for a maturity assessment of the postulated (or predicted) source rocks within the area of interest. In some embodiments, a heat flow model based on stratigraphy and/or well data may be used to perform a thermal model risk assessment (see FIG. 4, thermal model risk assessment 424). For example, one may evaluate the heat flow model by one or more simulation runs to validate geologic assumptions made about the area of interest. FIG. 22 illustrates the results 2200 for 30 simulation runs with varying input parameters, depicting a possible range of simulation results (e.g., one or more simulation runs with pre-determined shifts in input parameter values via a Monte Carlo simulation). A compilation 2300 of these results is given in FIG. 23. Coded bar 2302 below the section 2304 shows the “chance of success” for the source rock to be in the maturity window and likely to expel hydrocarbons at one point in time of the basins geologic history with lighter shaded areas that are more likely to be prospective with any combination of varying input parameters and darker shaded areas less likely to be prospective with any combination of varying input parameters.

For example, section 2302-6 of coded bar 2302 indicates a high chance of success, while section 2302-1 of coded bar 2302 indicates a low chance of success. These chances of success are related to transformation ratio chart 2306 that relates individual strata with one or more transformation ratios; while transformation ratio charts such as chart 2306 is discussed in greater detail below, an example of relating an individual strata with coded bar 2302 and transformation ratio chart 2306 is helpful in illustrating the relationship between the three. Strata 2308 is shaded in accordance with transformation ratio code 2306-1, which represents a transformation ratio of 75%, which in this example corresponds to a high chance of success as represented by section 2302-8 of coded bar 2302, thereby indicating a high chance of success.

While the results in FIG. 23 are depicted in grey scale and shading, those with skill in the art will appreciate that using color, numeric values, or other suitable indicia for the coding will be beneficial in some embodiments. Moreover, while a two-dimensional cross-section is depicted in the example of FIG. 23, the same techniques may be successfully applied to three-dimensional volumes being analyzed just as successfully.

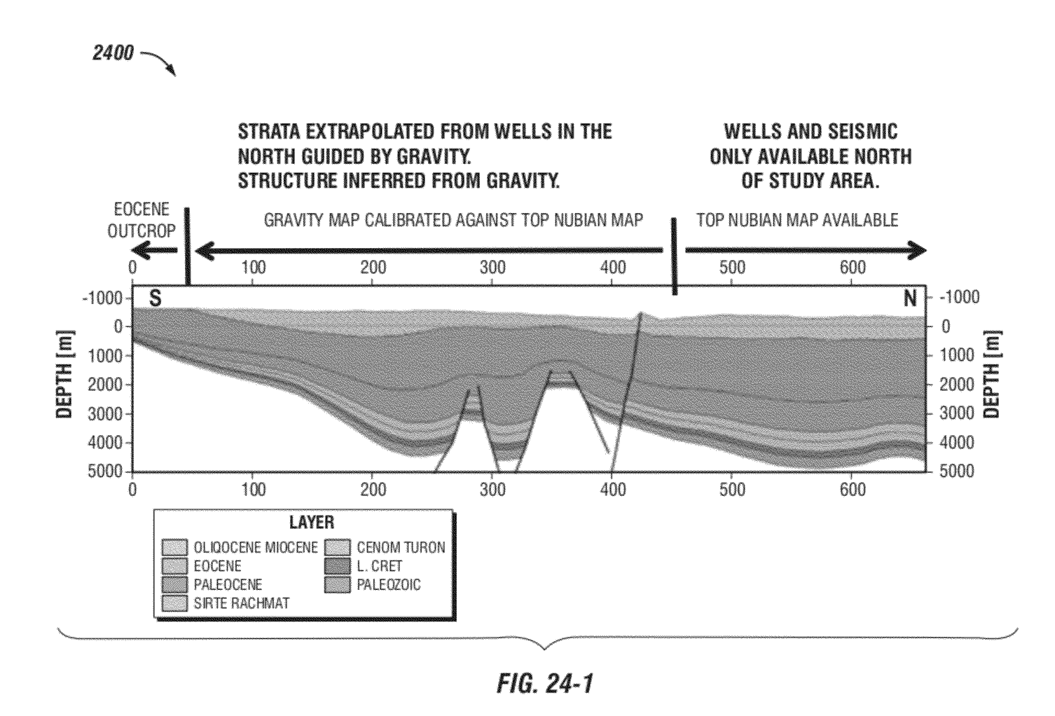

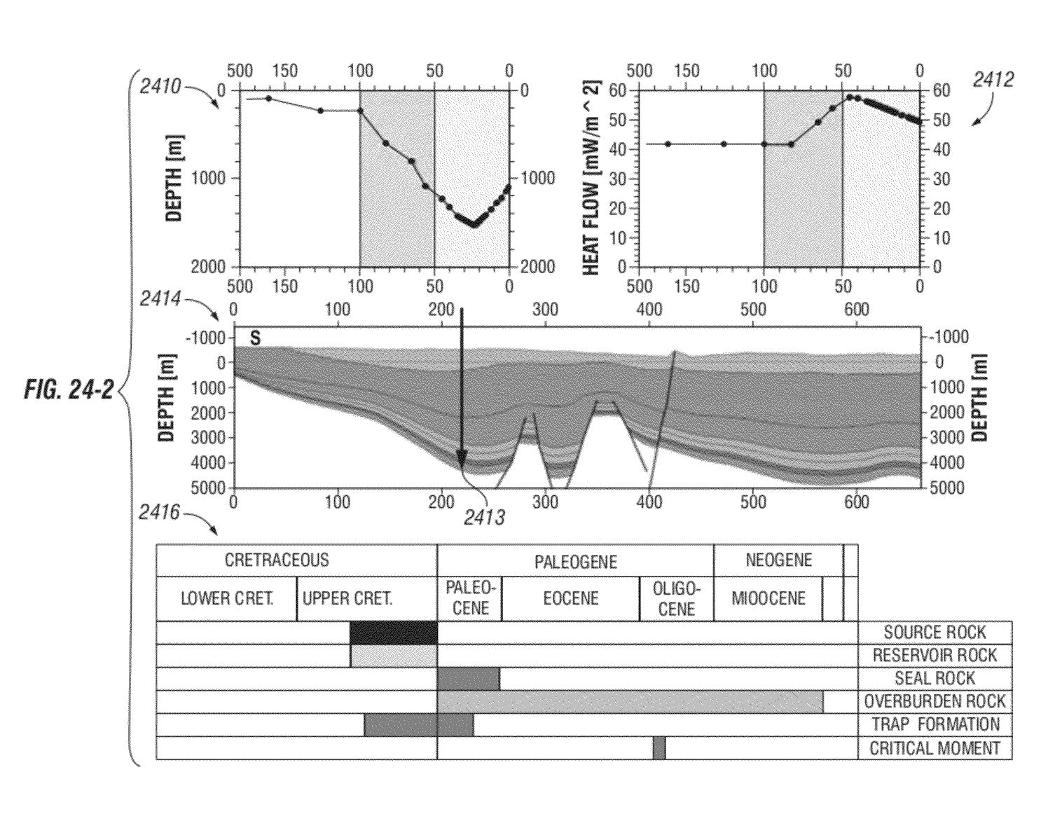

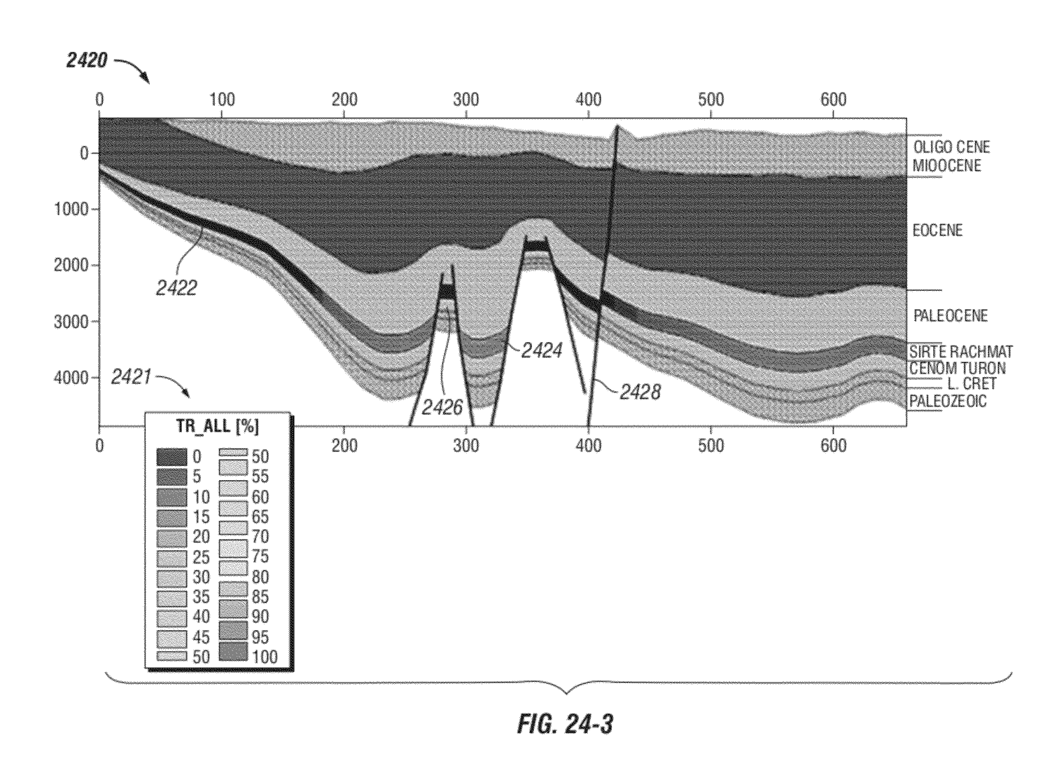

In some embodiments, a petroleum system model is generated (e.g., FIG. 4, petroleum system model 426), and it may be based at least in part on one or more of the data types discussed previously, including without limitation, the geological outline 404, the enhanced geological and structural map 406, the combined remote sensing map(s) 414, the calibrated subsurface density structure 418, and/or the thermal model and risk assessment 424 (and/or any of the preceding maps, data, and/or components, including geological maps and/or stratigraphic columns 402, DEMs 406, Optical and radar satellite images 408, surface elevation and topographic structures 412, satellite gravity data 410, and stratigraphy data, well data, and heat flow data 422). In FIG. 24-1, an example geometry input 2400 in the form of a 2D cross-section of the area of interest that includes geological era coding of sedimentary subterranean layers is illustrated. In this example, the subsidence history is depicted by the depositional time and the corresponding stratigraphic thickness. Geometry input 2400 serves as a starting point for generation of the petroleum system model.

FIG. 24-2 illustrates an example subsidence history 2410, in the form of a subsidence curve that is in accordance with some embodiments, and illustrates depth of content versus the relative time of its deposition within the sedimentary column corresponding to an area of interest; accordingly, subsidence history 2410 relates age of material, the thickness of material in the sedimentary column, and subsidence depth.

Heat flow model 2412, in the form of a heatflow curve that is in accordance with some embodiments, is also depicted in FIG. 24-2, and illustrates the corresponding heat flow model for the same area of interest. In this example, subsidence model 2410 and heat flow model 2142 are only shown for one point 2413 in stratigraphic section 2414. In some embodiments, a complete modeling of a stratigraphic section uses a data array of subsidence and heatflow model values to represent the subsidence and heatflow history of all formations within the stratigraphic section (2D) or stratigraphic volume (3D).

The modeling process is then used to estimate the conversion of potential kerogen contained in the sediments into hydrocarbons depending on subsidence history and heat flow history; in some embodiments, petroleum system events chart 2416 may be prepared based on the modeling process; in alternate embodiments, various methods to summarize and analyze modeling process results may be used successfully.

In the example illustrated in petroleum system events chart 2416, the deposition of sediments started in the Cretaceous period. These sediments contained kerogen and therefore represent potential source rocks. As soon as the shaly seal rock (i.e., rock including shale and functioning as a seal rock) had been deposited by the end of the Paleocene, the kerogen was trapped in the Cretaceous rocks. From now on the kerogen subsided with the Cretaceous rock matrix as the overburden sediments were deposited. Thereby the kerogen was exposed to increased pressure and heat at greater depth, which converted the kerogen into hydrocarbons.

A petroleum system is present if source rock, seal and trap are in place to enclose the hydrocarbons generated during the deposition and maturation process. The success of this transformation is measured by a transformation ratio, which can be illustrated by the example of chart 2421 shown in the petroleum system model 2420 in FIG. 24-3. Typically the transformation ratio is low at the basin flanks 2422 where the depth of subsidence has been shallow and the heatflow has been low. The most efficient transformation occurs in the deepest parts of the basin 2424 where subsidence was deep and heatflow high. This is the case in particular when geological structures such as faults and horsts 2426 prevent the migration of the hydrocarbons. In contrast, kerogen trapped in shallow horsts 2426 or in shallow parts adjacent to faults 2428 will show a low transformation ratio.

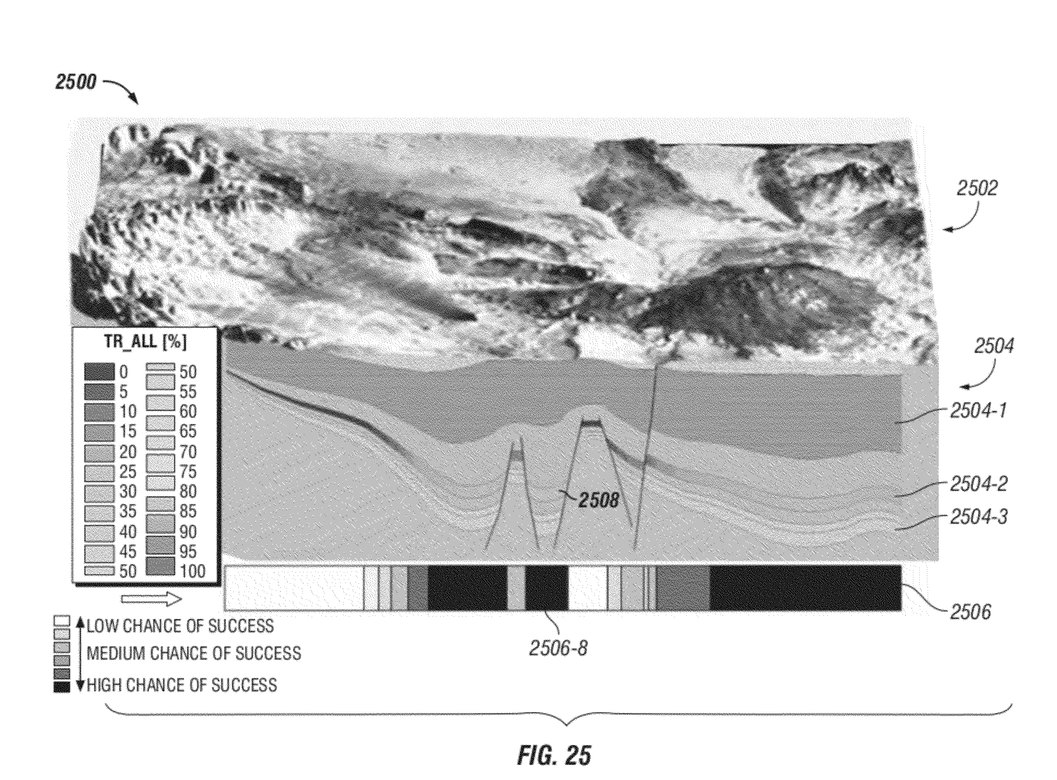

In some embodiments, an adjusted geological model (see, e.g., FIG. 25, three-dimensional compilation 2500) may be prepared based at least in part on the petroleum system model 426 and additional inputs, including but not limited to DEMs (e.g., FIG. 4, DEM 406) and enhanced geological and structural maps (e.g., FIG. 4, enhanced geological and structural map 416).

In some embodiments, such as the example three-dimensional compilation 2500 illustrated in FIG. 25, an adjusted geological model may include the topography of the surface 2502 and the crystalline basement 2504 as well as selected strata (e.g., 2504-1, 2504-2, and 2504-3, though not all strata are numbered in the three-dimensional compilation 2500 in FIG. 25), which are considered potential source, reservoir and seal rocks within the area of interest. In the example of FIG. 25, potential success scale 2506 illustrates the anticipated chances of success for finding a likelihood for kerogen maturation and hydrocarbon expulsion; lower chances of success are in lighter shades, medium chances of success are in a moderate shade, and high chances of success are in darker shades. Scale 2506 is correlated with one or more subsurface strata, some of which may be shaded with the likelihood estimates in scale 2506, e.g., strata 2504-2 is shaded with various success chance indicia at different locations within the area of interest, which allows the delineation of specific areas and zones with high hydrocarbon reservoir potential (in some embodiments, the success chance indicia that may be used to classify scale 2506 and/or strata within a crystalline basement may include the following non-limiting examples: different shades, different colors, varying numeric values, probability values, etc.). In some embodiments, the structure of the subsurface petroleum system may be inferred from the surface geomorphology and/or the structure of subsurface gravity and magnetic data. In the example of three-dimensional compilation 2500, potential reservoir 2508 may be identified within three-dimensional compilation 2500. In this example, identification of potential reservoir 2508 may be based at least in part on the correspondence between strata 2504-2's various success chance indicia, including within the vicinity of potential reservoir 2508 and scale 2506's likelihood estimate 2506-8.

As with FIG. 23, while FIG. 25 is depicted in grey scale and shading, those with skill in the art will appreciate that using color (or other suitable indicia) for the coding will be beneficial in some circumstances when preparing and/or analyzing adjusted geological models. Moreover, while only a single two-dimensional slice of the crystalline basement 2504 is depicted for ease of illustration, the same techniques may be successfully applied to three-dimensional volumes and areas of interest just as successfully to prepare fully three-dimensional adjusted geological models.

In some embodiments, based at least in part on petroleum systems model 2420, a geophysical survey decision may be made on whether to proceed with additional analysis of the area of interest (see, e.g., FIG. 4, geophysical survey decision 428). If a decision is made to continue analyzing the area of interest, a seismic survey design may be prepared (see, e.g., FIG. 4, initial seismic survey 430) based at least in part on the petroleum systems model 2420 and/or one or more of the data types and/or maps discussed previously.

In some embodiments, airborne remote sensing data may be used to prepare enhanced data regarding the area of interest, including enhanced surface structure maps. For example, airborne LiDAR surveys (see, e.g., FIG. 4 airborne LiDAR 432) may be conducted to prepare high-resolution surface topography maps (see, e.g., FIG. 4 high-resolution surface topography 434) to refine previously prepared enhanced surface structure maps (see, e.g., FIG. 4 enhanced surface structure 436).

In some embodiments, airborne remote sensing data may be used to prepare enhanced data regarding the area of interest, including high-resolution basin structural maps. For example, airborne gravity and/or magnetic surveys (see, e.g., FIG. 4 airborne gravity and magnetics 438) may be conducted to prepare high-resolution density and/or magnetic structure maps (see, e.g., FIG. 4 high-resolution density and/or magnetic structure 440) to prepare and/or refine previously prepared high-resolution basin structural maps (see, e.g., FIG. 4 high-resolution basin structure 442).

In some embodiments, petroleum system model 426 may also be based at least in part on enhanced surface structure 436, as well as one or more of the data types discussed previously.

In some embodiments, petroleum system model 426 may also be based at least in part on high-resolution basin structure 442, as well as one or more of the data types discussed previously. In some embodiments, high-resolution LiDAR, gravity and magnetic measurements are collected when the petroleum system modeling reveals a clear basin outline. In this case, the high-resolution data may be used for volumetric estimation of the hydrocarbons in the reservoir. High-resolution data may also be used when the petroleum system modeling originally based on lower resolution data reveals a complex reservoir structure. In both cases, the high-resolution data may be used to optimize (or refine) the area of the survey and to determine dominant structural orientations which may influence the orientation of the seismic survey.

In some embodiments, initial seismic survey design 430 may be refined to create a final seismic survey design 444 based at least in part on high-resolution basin structure 442 and/or enhanced surface structure 436.

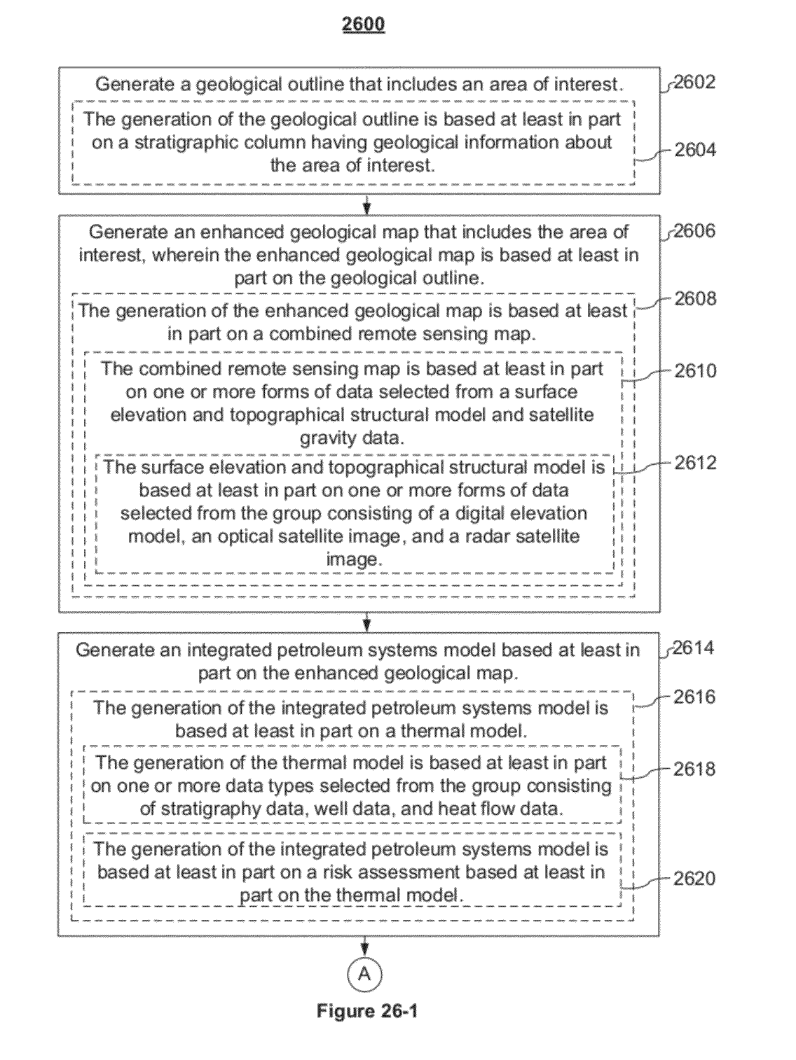

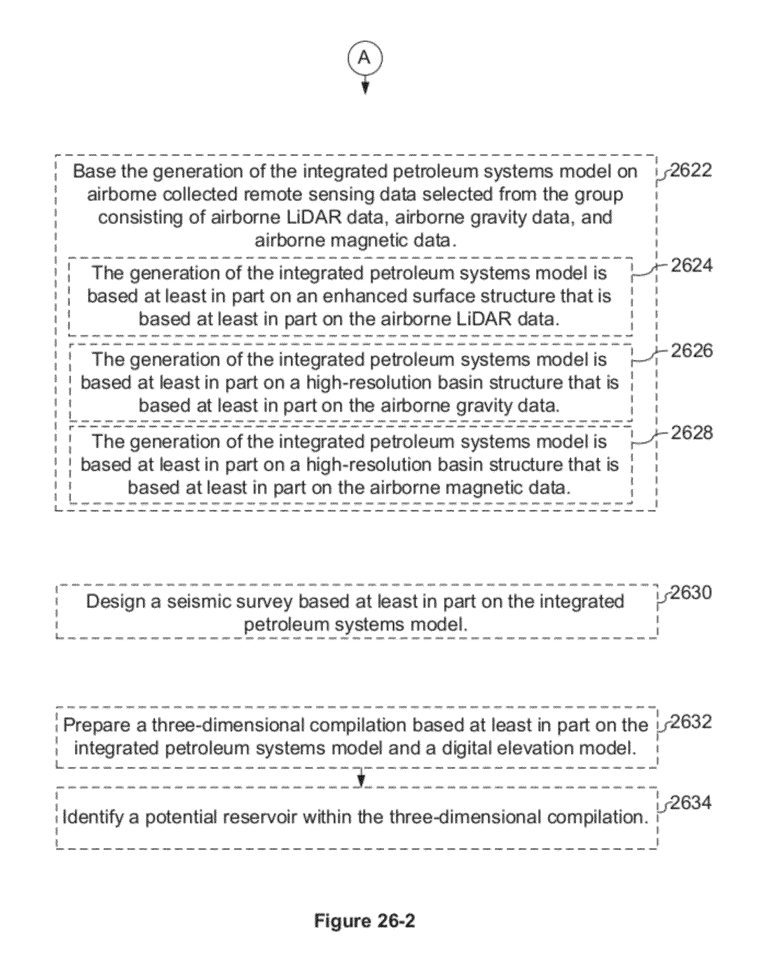

Attention is now directed to FIGS. 26-1 and 26-2, which are flow diagrams illustrating method 2600 for generating an integrated petroleum systems model in accordance with some embodiments. Some operations in method 2600 may be combined and/or the order of some operations may be changed. Further, some operations in method 2600 may be combined with aspects of the example workflows of FIGS. 2, 3 and/or FIG. 4, and/or the order of some operations in method 2600 may be changed to account for incorporation of aspects of the workflow illustrated by FIGS. 2, 3 and/or 4.

It is important to recognize that geologic interpretations, models and/or other interpretation aids may be refined in an iterative fashion; this concept is applicable to methods 200, 300, 400 and 2600 as discussed herein. This can include use of feedback loops executed on an algorithmic basis, such as at a computing device (e.g., computing system 100, FIG. 1), and/or through manual control by a user who may make determinations regarding whether a given step, action, template, model, or set of curves has become sufficiently accurate for the evaluation of the subsurface three-dimensional geologic formation under consideration.

Method 2600 involves a hydrocarbon exploration method that includes generation of an integrated petroleum systems model for at least part of an area of interest. In some embodiments, one or more aspects of method 2600 may be performed at a computing device (e.g., computing system 100, FIG. 1).

Method 2600 includes generating (2602) a geological outline that includes the area of interest (e.g., geological outline 301, FIG. 3; geological outline 404, FIG. 4).

In some embodiments, the generation of the geological outline is based at least in part on a stratigraphic column having geological information about the area of interest (2604) (e.g., geological outline 301, FIG. 3, is based on stratigraphic column 302; geological outline 404 is based on stratigraphic column 402, FIG. 4; FIG. 5 illustrates example stratigraphic column 500).

Method 2600 includes generating (2606) an enhanced geological map that includes the area of interest, wherein the enhanced geological map is based at least in part on the geological outline (see, e.g., enhanced geological and structural map 416, FIG. 4; gravity—lithology map 1600, FIG. 16; geomorphological map 1500, FIG. 15).

In some embodiments, the generation of the enhanced geological map is based at least in part on a combined remote sensing map (2608) (e.g., combined remote sensing maps 414, FIG. 4; gravity structure map 1400, FIG. 14).

In some embodiments, the combined remote sensing map is based at least in part on one or more forms of data selected from a surface elevation and topographical structural model and satellite gravity data (2610) (e.g., FIG. 4, DEM 406 and Optical and Radar Satellite Imagery 408 combined to generate surface elevation and topographical structure 412).

In some embodiments, the surface elevation and topographical structural model is based at least in part on one or more forms of data selected from the group consisting of a digital elevation model, an optical satellite image, and a radar satellite image (2612) (e.g., FIG. 4, DEM 406 and Optical and Radar Satellite Imagery 408 combined to generate surface elevation and topographical structure 412).

Method 2600 includes generating (2614) the integrated petroleum systems model based at least in part on the enhanced geological map (e.g., FIG. 4, enhanced geological and structural map 416 as input to petroleum system model 426).

In some embodiments, the generation of the integrated petroleum systems model is based at least in part on a thermal model (2616) (e.g., FIG. 4, thermal model risk assessment 424 as input to petroleum system model 426).

In some embodiments, the generation of the thermal model is based at least in part on one or more data types selected from the group consisting of stratigraphy data, well data, and heat flow data (2618) (e.g., FIG. 4, thermal model risk assessment 424 includes inputs from stratigraphy, well data, and heat flow data 422).

In some embodiments, the generation of the integrated petroleum systems model is based at least in part on a risk assessment based at least in part on the thermal model (2620) (e.g., FIG. 4, thermal model risk assessment 424; FIG. 22 simulation results 2200).

In some embodiments, method 2600 also includes basing (2622) the generation of the integrated petroleum systems model at least in part on airborne collected remote sensing data, which may be selected from the group consisting of airborne LiDAR data, airborne gravity data, and airborne magnetic data (e.g., FIG. 4, airborne LiDAR 432, airborne gravity 438, and airborne magnetic 438 as input to petroleum systems model 426 via blocks 434, 436 and 440, 442, respectively).

In some embodiments, the generation of the integrated petroleum systems model is based at least in part on an enhanced surface structure that is based at least in part on the airborne LiDAR data (2624) (e.g., FIG. 4, enhanced surface structure 438 as input to petroleum systems model 426, and enhanced surface structure 438 takes as input airborne LiDAR data 432).

In some embodiments, the generation of the integrated petroleum systems model is based at least in part on a high-resolution basin structure that is based at least in part on the airborne gravity data (2626) (e.g., FIG. 4, high resolution basin structure 442 as input to petroleum systems model 426, and high resolution basin structure 442 takes as input airborne gravity data 438).

In some embodiments, the generation of the integrated petroleum systems model is based at least in part on a high-resolution basin structure that is based at least in part on the airborne magnetic data (2628) (e.g., FIG. 4, high resolution basin structure 442 as input to petroleum systems model 426, and high resolution basin structure 442 takes as input airborne magnetic data 438).

In some embodiments, method 2600 also includes designing (2630) a seismic survey based at least in part on the integrated petroleum systems model (e.g., FIG. 4, initial seismic survey design 430 and final seismic survey design 444 both take as inputs petroleum system model 426 following making a geophysical survey decision 428).

In some embodiments, method 2600 also includes preparing (2632) a three-dimensional compilation based at least in part on the integrated petroleum systems model and a digital elevation model (e.g., FIG. 25, three-dimensional compilation 2500). In some embodiments, method 2600 also includes identifying (2634) a potential reservoir within the three-dimensional compilation (e.g., FIG. 25, identification of potential reservoir 2508 within three-dimensional compilation 2500).

While examples and references are made herein to kerogen and conversion of potential kerogen in the context of hydrocarbon exploration, those with skill in the art will recognize that the methods, techniques, and workflows disclosed herein may be successfully utilized for seeking any organic matter that may be converted into hydrocarbons.

The steps in the processing methods described above may be implemented by running one or more functional modules in information processing apparatus such as general purpose processors or application specific chips, such as ASICs, FPGAs, PLDs or other appropriate devices. These modules, combinations of these modules, and/or their combination with general hardware are all included within the scope of protection of the invention.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A hydrocarbon exploration method, comprising:
generating an integrated petroleum systems model for at least part of an area of interest, wherein the model generation includes:
generating a geological outline that includes the area of interest;
generating an enhanced geological map that includes the area of interest, wherein the enhanced geological map is based at least in part on the geological outline; and
generating the integrated petroleum systems model based at least in part on the enhanced geological map.

2. The method of claim 1, wherein the generation of the geological outline is based at least in part on a stratigraphic column having geological information about the area of interest.

3. The method of claim 1, wherein the generation of the enhanced geological map is based at least in part on a combined remote sensing map.

4. The method of claim 3, wherein the combined remote sensing map is based at least in part on one or more forms of data selected from a surface elevation and topographical structural model and satellite gravity data.

5. The method of claim 4, wherein the surface elevation and topographical structural model is based at least in part on one or more forms of data selected from the group consisting of a digital elevation model, an optical satellite image and a radar satellite image.

6. The method of claim 1, wherein the generation of the integrated petroleum systems model is based at least in part on a thermal model.

7. The method of claim 6, wherein the generation of the thermal model is based at least in part on one or more data types selected from the group consisting of stratigraphy data, well data, and heat flow data.

8. The method of claim 6, wherein the generation of the integrated petroleum systems model is based at least in part on a risk assessment based at least in part on the thermal model.

9. The method of claim 1, further comprising basing the generation of the integrated petroleum systems model on airborne collected remote sensing data selected from the group consisting of airborne LiDAR data, airborne gravity data, and airborne magnetic data.

10. The method of claim 9, wherein the generation of the integrated petroleum systems model is based at least in part on an enhanced surface structure that is based at least in part on the airborne LiDAR data.

11. The method of claim 9, wherein the generation of the integrated petroleum systems model is based at least in part on a high-resolution basin structure that is based at least in part on the airborne gravity data.

12. The method of claim 9, wherein the generation of the integrated petroleum systems model is based at least in part on a high-resolution basin structure that is based at least in part on the airborne magnetic data.

13. The method of claim 1, further comprising designing a seismic survey based at least in part on the integrated petroleum systems model.

14. The method of claim 1, further comprising preparing a three-dimensional compilation based at least in part on the integrated petroleum systems model and a digital elevation model.

15. The method of claim 14, further comprising identifying a potential reservoir within the three-dimensional compilation.

16. A computing system, comprising:
at least one processor;
at least one memory; and
one or more programs stored in the at least one memory, wherein the one or more programs are configured to be executed by the one or more processors, the one or more programs including instructions for:
generating an integrated petroleum systems model for at least part of an area of interest, wherein the integrated petroleum systems model is based at least in part on:
a geological outline,
a set of satellite remote sensing data, and
a set of airborne remote sensing data.

17. A method, comprising:
at a computing system for hydrocarbon exploration:
displaying a graphical user interface; and
displaying a three-dimensional compilation within the graphical user interface, wherein the three-dimensional compilation is based at least in part on an integrated petroleum systems model.
